(19) United States
(12) Patent Application Publication
(10) Pub. No.: US 2020/0208035 A1
(43) Pub. Date: Jul. 2, 2020

(54) FIBER AND NANOMATERIAL COMPOSITE MATERIAL AND METHOD FOR MAKING THEREOF

(71) Applicant: Aleksandar GRUJICIC, Westmount (CA)

(72) Inventor: Aleksandar GRUJICIC, Westmount (CA)

(21) Appl. No.: 16/712,319

(22) Filed: Dec. 12, 2019

Related U.S. Application Data
(62) Division of application No. 14/712,486, filed on May 14, 2015, now abandoned.
(60) Provisional application No. 61/992,997, filed on May 14, 2014.

(51) Int. Cl. C09K 5/14

(52) U.S. Cl. CPC C09K 5/14; B32B 2305/076; B32B 2262/106; Y10T 428/31511

(57) ABSTRACT

A new method for the making of a new composite of nanomaterials and fibers is disclosed, comprising at least a step in which the nanomaterials are incorporated into the fiber preform by applying ultrasound to an impregnated fiber preform and iterating the steps of the method until to obtain a desired concentration of nanomaterial incorporated into the composite. The method allows obtaining uniform composite of high quality with higher thermal conductivity which are also part of the present invention. A new ancillary material stacking sequence incorporating nanomaterial/fibers composite is also disclosed, in which the ancillary sequence is placing breather and bleeder between the release film and curing tool in order to eliminate accumulated matrix against the tool plate.

### CROSS-REFERENCE TO RELATED APPLICATIONS

The present patent application is a divisional of U.S. non-provisional patent application Ser. No. 14/712,486, entitled “FIBER AND NANOMATERIAL COMPOSITE MATERIAL AND METHOD FOR MAKING THE SAME”, filed on May 14, 2015, which claims the priority of U.S. provisional Patent Application No. 61/992,997, entitled “Fiber and nanomaterial composite material and method therefore”, filed on May 14, 2014, each of which is incorporated by reference as if expressly set forth in their respective entirety herein.

### FIELD OF THE INVENTION

The present invention generally relates to composite material and methods for making these materials. In particular, the composite materials comprise fibers and nanomaterials such as but not limited to carbon nanotubes (CNTs).

### BACKGROUND OF THE INVENTION

Composite materials are replacing traditional materials like metals in nearly every imaginable domain. The reason for it resides in the fact that composite materials can have similar mechanical properties to metals while their weight is significantly lower. This property is important for many applications, notably automotive and aerospace industries. However, the application of composite materials in certain areas remains challenging. One of these areas is elevated temperature operating conditions. Parts operating in the elevated temperature environment are required to dissipate heat well. The physical property that determines part heat dissipation quality is part material thermal conductivity.

Materials used to produce composite materials parts are different fibers, one being carbon fiber, and a large variety of plastics, either thermoset or thermoplastic. Carbon fibers can be made from pitch or polyacrylonitrile (PAN) precursors. Pitch based carbon fibers possess excellent thermal conductivity, however, their mechanical properties limit their application. On the other hand, widely used polyacrylonitrile based carbon fibers are excellent heat conductors along the fiber, however fiber thermal conductivity perpendicular to the fiber is far smaller. The plastics used to give form to parts made from carbon fibers are in general terms thermal insulators. Combined together, carbon fibers and plastics have better thermal conductivity than the plastics, nonetheless insufficient for engineering applications where heat dissipation is the determining factor in material choice.

At the end of the twentieth century, carbon nanotubes attracted significant attention of the scientific community. A method was discovered to produce them in quantities sufficient for characterization and application related research. Carbon nanotubes were found to be a material with exceptional mechanical, thermal and electrical properties. Such properties made them prime candidate to add to existing composite materials in order to obtain truly multifunctional composite materials with high electrical and thermal conductivity in all directions as well as improved mechanical properties.

Large amount of effort was put into improving composite materials thermal conductivity in order to obtain multifunctional composites with the addition of carbon nanotubes. However, carbon nanotubes high thermal conductivity did not result in very high thermal conductivity of composite materials. This was particularly applicable in the through thickness direction while certain methods were giving good results for in plane thermal conductivity. Many obstacles were identified on the road to the envisioned goal. Interface, both carbon nanotube—matrix and carbon nanotube—carbon nanotube, non-perfect crystal lattice of a carbon nanotube, high anisotropy of carbon nanotubes, dispersion quality are some of the issues encountered when improved thermal conductivity was sought.

Carbon Nanotubes (CNTs)—Multiwall Carbon Nanotubes (MWNT), 50 nm in diameter—were discovered in 1952 by Radushkevich and Lukyanovich [L. V. Radushkevich; V. M. Lukyanovich; Zurn Fizic Himii 1952, 26: 88-95; M. Monthioux; V. L. Kuznetsov; Carbon 2006, 44: 1621-1623]. Single Wall Carbon Nanotubes (SWNT)—tubular structures with the diameter in the 1 nm range and the walls being of a single atom dimension thickness with carbon hexagon helical arrangement—were first observed by two independent teams [M. Monthioux; V. L. Kuznetsov; Carbon 2006, 44: 1621-1623]: a Japan team S. Iijima and T. Ichihashi [S. Iijima, T. Ichihashi; Nature 1993, 363: 603-605] and a US team Bethune et al. [D. S. Bethune, C. H. Kiang, M. S. de Vries, G. Gorman, R. Savoy, J. Vasquez, R. Beyers; Nature 1993, 363: 605-607]. Tubule structure can be described uniquely following Hamada notation. Carbon nanotubes are an allotrope of carbon that can be represented as a sheet of graphite rolled in a cylinder. If the structure consists of a single cylinder, the CNT is a Single Wall Carbon Nanotube (SWNT). Where multiple cylinders are present, concentric about the tube axis, the CNT is a Multiwall Carbon Nanotube (MWNT). If only two concentric tubules are present, it is a Double Wall Carbon Nanotube (DWNT). Hexagons consisting of carbon-atoms are arranged about the tube axis helically. [N. Hamada, S. Sawada, A. Oshiyama; Physical Review Letters 1992, 68: 1579-1581].

As CNTs are in essence a graphite sheet rolled into a cylinder, they could be expected to possess thermal conductivity (TC) similar to those of graphite sheet and diamond [J. Hone, M. Whitney, C. Piskoti, A. Zettl; Physical Review B 1999, 59: 2514-2516]. Graphitic tubules may possess as well unusual mechanical, electronic and optical properties with a wide range of technological applications (e.g. nanoscale devices, light-weight and high strength composite materials etc.) because of their crystalline perfection, various possible helical structures, the dimensionality and the high efficiency of production [J. Yu, R. K. Kalia, P. Vashishta; Journal of Chemical Physics 1995, 103: 6697-6705]. Another possible application is heat dissipation on micro and macro scale. TC is the determining factor when choosing material for thermal management.

In the crystal lattice structure, heat is carried via phonons. The resistance to the heat transport is coming from phonon-phonon interactions and scattering from imperfections in the lattice and on the lattice boundary. The imperfections can be vacancies, inserted atoms and impurities. At the crystal lattice boundary a phonon is scattered more if the mismatch in the elastic properties of the structure on the other side of the boundary is higher [J. M. Ziman: Electrons and Phonons: The Theory of Transport Phenomena in Solids, Oxford Scholarship Online, 2007]

In a highly anisotropic material like CNTs is likely that even in nanotube bundles, the TC should directly probe on-tube phonons and be insensitive to inter-tube mechanical coupling [J. Hone, M. C. Llaguno, M. J. Biercuk, A. T. Johnson, B. Batlogg, Z. Benes, J. E. Fischer; Appl. Phys. A 2002, 74: 339-343].

TC of CNTs was determined experimentally and numerically. Both SWNT and MWNT TCs were measured. Experimental determination of TC of various forms gave better insight in differences between individual CNTs, aligned and non aligned bundles, yarns, mats and forests, impact of number of walls, defects and higher forms on TC and in one case correlation between the TC and structural defect concentration [P. Kim, L. Shi, A. Majumdar, P. L. McEuen; Physical Review Letters 2001, 87: 215502-1 215502-4; E. Pop, D. Mann, J. Cao, Q. Wang, K. Goodson, H. Dai; Physical Review Letters 2005, 95: 155505-1-155505-4; C. Yu, L. Shi, Z. Yao, D. Li, A. Majumdar, Nano Letters 2005, 5: 1842-1846; M. T. Pettes, L. Shi; Advanced Functional Materials 2009, 19: 3918-3925; A. E. Aliev, M. H Lima, E. M. Silverman, R. H. Baughman; Nanotechnology 2010, 21: 035709-1-11; J. Guo, X. Wang; Journal of Applied Physics 2007, 101: 063537-1-063537-7; T. Wang, X. Wang, J. Guo, Z. Luo, K. Cen; Applied Physics A 2007, 87: 599-605; J. Guo, X. Wang, D. B. Geohegan, G. Eres, and C. Vincent; Journal of Applied Physics 2008, 103: 113505-1-113505-9; M. B. Jakubinek, M. B. Johnson, M. A. White, C. Jayasinghe, G. Li, W. Cho, M. J. Schulz, V. Shanov; Carbon 2012, 50: 244-248; J. Hone, M. C. Llaguno, N. M. Nemes, A. T. Johnson, J. E. Fischer, D. A. Walters, M. J. Casavant, J. Schmidt, and R. E. Smalley; Applied Physics Letters 2000, 77: 666-668; B. Zhao, D. N. Futaba, S. Yasuda, M. Akoshima, T. Yamada, and K. Hata; ACS Nano 2008, 3: 108-114; M. Akoshima, K. Hata, D. N. Futaba, K. Mizuno, T. Baba, M. Yumura; Japanese Journal of Applied Physics 2009, 48: 05EC07-1-6]. Molecular dynamic simulations and kinetics model predicted TC of SWNTs, SWNT bundles and MWNT as well as impact of tube chirality, defects and lengths of the temperature-controlled sections [S. Berber, Y-K Kwon, D. Tománek; Physical Review Letters 2000, 84: 4613-4616; R. A. Shelly, K. Toprak, Y. Bayazitoglu; International Journal of Heat and Mass Transfer 2010, 53: 5884-5887; X. H. Yan, Y. Xiao, Z. M. Li; Journal of Applied Physics 2006, 99: 124305-1-124305-4].

Theoretical estimations, experimental results and numerical simulations, all gave very high values of CNTs and their macroscopic forms TC. Obtaining polymer based nanocomposites incorporating CNTs with TC sufficient for thermal management was the next step. Experimental work and numerical simulations were employed.

At first nanocomposites contained polymer and CNTs. These composites did not have desired TC. Phenomena cited was poor CNT dispersion, high viscosity of CNT-polymer mixture, poor quality of CNT/polymer interface, high tube-tube and tube polymer interface resistance, random CNT dispersion.

Different techniques were employed to overcome these issues. Sonication to disperse CNTs [M. J. Biercuk, M. C. Llaguno, M. Radosavljevic, J. K. Hyun, A. T. Johnson, J. E. Fischer; Applied Physic Letters 2002, 80: 2767-2769], employing sequential layering of CNTs and polyelectrolytes (layer-by-layer (LBL) technique) to obtain highly homogeneous SWNT composite with SWNT content of 50±5 wt % [N. A Kotov, A. A Memedov, M. Prato, D. M. Guldi, J. Wicksted, A. Hirsch; SPIE Proceedings 2004, 5166: 228-237], making highly heterogeneous sample prepared with freestanding SWNT framework to reduce CNT/CNT interfacial resistance [F. Du, C. Guthy, T. Kashiwagi, J. E. Fischer, K. I. Winey; Journal of Polymer Science: Part B: Polymer Physics 2006, 44: 1513-1519], preparing composites via coagulation method from PMMA and chemical vapour deposition (CVD) SWNTs and MWNTs purified in acid and dispersed using ultrasound [W.-T. Hong, N.-H. Tai; Diamond & Related Materials 2008, 17: 1577-1581]. M. Wirts-Riitters et al. increased TC linearly with the MWNT content compared to the pure epoxy matrix independent of the degree of dispersion and the MWNT type, functionalised or as received. [M. Wirts-Riitters, M. Heimann, J. Kolbe, K.-J. Wolter; 2nd Electronics System Integration Technology Conference 2008, 1057-1062].

Functionalisation of CNTs was another approach to increase nanocomposites TC. This was done to improve interfacial heat transport as well as to improve dispersion [Kai Yang, Mingyuan Gu, Yiping Guo, Xifeng Pan, Guohong Mu; Carbon 2009, 47: 1723-1737]. However, functionalization in general damages CNTs as shown by Wang et al. Acid oxidized—functionalized CNT has etched surface while microtome cut SWNT has smooth surface [S. Wang, R. Liang, B. Wang, C. Zhang; Carbon 2009, 47: 53-57]. To avoid damaging, MWNTs were functionalised via Friedel-Crafts modification [S.-Y. Yang, C.-C. M. Ma, C.-C. Teng, Y.-W. Huang, S.-H. Liao, Y.-L. Huang, H.-W. Tien, T.-M. Lee, K.-C. Chiou; Carbon 2010, 48: 592-603]. This approach increased TC compared to pristine MWNTs composites due to: a) rigid linkage between MWNTs and epoxy matrix, b) good dispersion of MWNTs in matrix. Molecular dynamic simulations were predominant numerical simulation employed to predict functionalised CNTs TC. The functionalization of SWNTs reduces their TC [B.-H. Chen, C.-H. Lan, M.-S. Jeng, C.-J. Huang, M.-L. Chang, F.-H. Tsau, J.-R. Ku, S.-Y. Lin; International Symposium on Computer, Communication, Control and Automation 2010, 314-317], while the thermal diffusivity of the metal-coated SWNTs decrease by 90% [S. Inoue, Y. Matsumura; Journal of Thermal Science and Technology 2011, 6: 256-267].

Adding CNTs to polymer matrix in high loadings could represent a formidable task. Carbon nanotubes are not an inexpensive material either. Hence, improving TC with low loading of CNTs is another approach towards commercialisation of nanocomposites. TC of nanocomposites from PMMA and UV/03 functionalised MWNTs on which aniline was deposited and Ag added improved polymer TC [Ramsha R., Saqib A., Fiaz A., Shafiq U., J. T. Grant, Javed I.; Polymer Composites 2011: 1757-1765].

CNTs magnetic alignment was employed to overcome random dispersion [E. S. Choi, J. S. Brooks, D. L. Eaton, M. S. Al-Haik, M. Y. Hussaini, H. Garmestani, D. Li, K. Dahmen; Journal of Applied Physics 2003, 94: 6034-6039]. Direct epoxy infiltration into CNTs assembled parallel to each other into fibers during CVD production process created high volume fraction composites with aligned CNTs [J. J. Vilatela, R. Khare, A. H. Windle; Carbon 2011, 50: 1227-1234]. This gave good result.

To further improve properties while simplifying the production process polymer electrospinning was used. Electric field aligned CNT combined with graphite particles loaded cellulose acetate fibers were electrospun to improve the network of thermally conductive nanoparticles [V. Datsyuk, I. Firkowska, K. Gharagozloo-Hubmann, M. Lisunova, A.-M. Vogt, A. Boden, M. Kasimir, S. Trotsenko, G. Czempiel, S. Reich; 27th IEEE SEMI-THERM Symposium 2011: 325-332]. MWNT-polybenzimidazole nanofiber composites were produced by core-shell electrospinning [V. Datsyuk, S. Trotsenko, S. Reich; Carbon 2013, 52: 605-608].

CNT/polymer composites had neither expected conductivity nor mechanical properties. Hence, attempts were made to improve carbon fiber reinforced plastics (CFRP) with the addition of CNTs. Pitch based carbon fibers (CF) were impregnated with phenolic resin containing crystalline CVD MWNT [Y. A. Kim, S. Kamio, T. Tajiri, T. Hayashi, S. M. Song, M. Endo, M. Terrones, M. S. Dresselhaus; Applied Physics Letters 2007, 90: 093125-1-93125-3]. Amine groups (NH2) functionalised MWNTs were deposited on polyacrylonitrile (PAN) CFs using electrophoretic deposition process and cured with epoxy resin. Possible covalent bonding between CFs and MWNTs was observed [M. Theodoore, J. Fielding, K. Green, D. Dean, N. Horton, A. Noble, S. Miller; SAMPE Conference Proceedings 2009, 54: 18 pages]. These increased TC. Some attempts were not as successful as others. These are important in order to understand the available paths that could lead to desired results. Spraying carbon fiber prepreg surface with carboxylic acid groups functionalised SWNTs did not improve TC as SWNTs remained between layers [L. Yoo, H. Kim; International Journal of Precision Engineering and Manufacturing 2011, 12: 745-748]. SWNTs, chopped mesophase pitch base CF K-1100, and carbon black (CB) were added via immersion on both surfaces of PAN based CFs/epoxy prepreg sheet. Through thickness TC increased [S. Han, D. D. L. Chung; Composites Science and Technology 2011, 71: 1944-1952]. Long MWNTs (LMWNT—over 1 mm in length) mixed with Epon 862 epoxy using three roll mill were incorporated into the carbon fiber fabric to improve composite TC. Only samples with 10 wt % of LMWNT made the difference in TC. Due to induced loading better result was obtained for short MWNTs at 0.5 wt % CNT loading [M. Zimmer, Q. Cheng, S. Li, J. Brooks, R. Liang, B. Wang, C. Zhang; Journal of Nanomaterials 2012, 532080-1-9].

Filtration effect was cited to be the reason for small TC improvement. Hence modification of CFs and CF preforms with the addition of CNTs was attempted. First, CNTs were grown directly on fibers. CNTs were grown on PAN and pitch based carbon fibers using CVD method. Resulting materials TC increased significantly [K. Naito, J.-M. Yang, Y. Xu, Y. Kagawa; Carbon 2010, 48: 1849-1857]. Following CNT growth on CFs, in order to form CFRP, polymer was added to the modified preform. Different wt % of MWNTs were grown via CVD on PAN CF substrates to make composites with epoxy matrix. Both in-plane and through thickness TCs were improved [R. B. Mathur, B. P. Singh, P. K. Tiwari, T. K. Gupta; International Journal of Nanotechnology 2012, 9: 1040-1049].

Step by step, thermal conductivity was improved on macroscopic scale with testing results approaching functional materials thermal conductivity values. However, better results were obtained for the thermal conductivity in the direction of CNTs and CNT modified CFs than in the through thickness direction which remains challenging area with considerable space for improvement. Therefore, incorporation of CNTs in CFRP has a substantial potential for applications where heat dissipation is a concern.

Graphene was produced, isolated, identified and characterised recently by Novoselov and Geim [Class for Physics of the Royal Swedish Academy of Sciences: Scientific background on the Nobel Prize in Physics 2010]. The graphene is a 2D material and has excellent thermal conductivity properties [A. A. Balandin, S. Ghosh, W. Bao, I. Calizo, D. Teweldebrhan, F. Miao, C. N. Lau; Nano Letters 2008, 8: 902-907]. Thus ensuing attempts to improve composites TC through graphene as filler, alone or in combination with CNTs resulted in TC significant enhancement. Graphite nano platelets (GNP) combined with SWNTs yielded higher TC improvement than either GNP or SWNTs loaded composite up to 20 wt % filler loading. Above 25 wt % loading, GNP composites had higher thermal conductivity than hybrid filler composite [A. Yu, P. Ramesh, X. Sun, E. Bekyarova, M. E. Itkis, R. C. Haddon; Advanced Materials 2008, 20: 4740-4744]. Conventional thermal interface materials (TIMs) require high volume fractions of the filler (˜70%). Multi layer graphene and liquid phase exfoliated graphene significantly improve TC with 10% graphene volume fraction [K. M. F. Shahil, V. Goyal, R. Gulotty, A. A. Balandin; 2012 IEEE Silicon Nanoelectronics Workshop (SNW), p 2 pp., 2012]. Flat GNP have advantage over wrinkled GNP as a filler for TC improvement [Ke Chu⋅Wen-sheng Li⋅Hongfeng Dong; Applied Physics A 2013, 111: 221-225]. Equal amounts of GNP and CNT filler were used to load epoxy with up to 50 vol % nanomaterial. The large TC enhancement was, as in previous cases, attributed to synergetic effects of the two fillers [X. Huang, C. Zhi, P. Jiang; The Journal of Physical Chemistry 2012, 116: 23812-23820]. To exploit combined properties of GNP and CNTs, CNTs were grown on GNP. This filler gave better composite thermal conductivity than either GNP or CNTs on its own. [L. Yu, J. S. Park, Y.-S. Lim, C. S. Lee, K. Shin, H. J. Moon, C.-M. Yang, Y. S. Lee, J. H. Han; Nanotechnology 2013, 24: 155604 (7pp)].

Functionalisation was attempted on graphene as well. Non covalent functionalisation does not induce a great damage to graphene flakes and renders them highly soluble [S. H. Song, K. H. Park, B. H. Kim, Y. W. Choi, G. H. Jun, D. J. Lee, B.-S. Kong, K.-W. Paik, S. Jeon; Advanced Materials 2013, 25: 732-737]. TC of functionalised graphite/epoxy composite increased 28 fold. However, the electrical property declined [S. Ganguli, A. K. Roy, D. P. Anderson; Carbon 2008, 46: 806-817]. Other studies determined that graphene improves epoxy electrical properties, however to lesser extent than CNTs. MWNT were forming percolation network at lower loading levels than graphene sheets, designating CNTs as better filler for electrical properties improvement [M. Martin-Gallego, M. M. Bernal, M. Hernandez, R. Verdejo, M. A. Lopez-Manchado; European Polymer Journal 2013, 49: 1347-1353]. Pristine MWNT added to epoxy improved electrical conductivity about two orders of magnitude more than added graphene nanosheets. Percolation network for arbitrary electrical conductivity threshold was achieved with more graphene nanosheets than with MWNT. [Z. He, X. Zhang, M. Chen, M. Li, Y. Gu, Z. Zhang, Q. Li; Journal of Applied Polymer Science 2013: 3366-3372].

As presented above, graphene is a promising material for thermal conductivity improvement. However, through thickness thermal conductivity of hybrid material comprising carbon fibers, graphene and polymer matrix was not reported. In the same time, CNTs appear to be the material of choice for electrical conductivity improvement. Hence, CNTs appear to be better suited to develop multifunctional composite material.

There is thus a need for a new method for the making of a new composite including nanomaterial and fibers with enhanced properties such as enhanced thermal conductivity.

Other and further objects and advantages of the present invention will be obvious upon an understanding of the illustrative embodiments about to be described or will be indicated in the appended claims, and various advantages not referred to herein will occur to one skilled in the art upon employment of the invention in practice.

### SUMMARY OF THE INVENTION

The aforesaid and other objectives of the present invention are first realized by generally providing a method for the making of a composite of nanomaterials and fibers. The method comprising the steps of:
a) dispersing a given amount of nanomaterials into a solvent to obtain a solution while maintaining the solution at a first constant temperature in order to uniformly disperse the nanomaterial in the solvent;
b) impregnating a dry fiber preform comprising fibers with the solution obtained in step b);
c) incorporating the nanomaterials into the fiber preform by applying ultrasound to the impregnated fiber preform obtained in step b) at a second constant temperature;
d) removing the solvent from the impregnated fiber preform obtained in step c); and
e) iterating steps a) to d) at least once wherein in iterated step b) the fiber preform is replaced with the impregnated fiber preform obtained in step d) in the previous iteration, until to obtain a first amount of nanomaterial incorporated into the composite.

The invention is also directed to a composite of nanomaterials and fibers obtained by the method defined herein, the composite may comprise nanomaterials with a concentration up to 50 wt. %.

The invention is further directed to an ancillary material stacking sequence comprising the following sequences:
a) at least one first breather placed against a curing tool;
b) at least one first bleeder placed on the breather(s);
c) a first release film placed on the bleeder(s);
d) a composite comprising nanomaterials and fibers placed on the release film;
e) a second release film placed on the composite;
f) at least one second bleeder placed on the second release film;
g) at least one second breather placed on the second bleeder(s); and
h) a vacuum bag sealed on the second breather and the curing tool, using a sealing tape.

Preferably, in sequence d), the composite comprising nanomaterials and fibers is the composite as defined herein.

The invention is also directed to a method for the making of an ancillary material stacking sequence comprising the following steps:
a) placing at least one first breather against a curing tool;
b) placing at least one first bleeder on the breather(s);
c) placing a first release film on the bleeder(s);
d) placing a composite comprising nanomaterials and fibers on the release film;
e) placing at least one second release film on the composite;
f) placing at least one second bleeder on the second release film;
g) placing at least one second breather on the second bleeder(s); and
h) sealing a vacuum bag over the second breather (1315) on the curing tool.

Preferably, in step d) above, the composite comprising nanomaterials and fibers is the composite in accordance with the present invention.

The features of the present invention which are believed to be novel are set forth with particularity in the appended claims.

### BRIEF DESCRIPTION OF THE DRAWINGS

The above and other objects, features and advantages of the invention will become more readily apparent from the following description, reference being made to the accompanying drawings in which:

FIG. 1 illustrates, in schematically general terms, a method for the making of fibers/nanomaterial composite material in accordance with a preferred embodiment of the invention;

FIG. 2 is a picture showing mixing of a nanomaterial (such as CNTs) and a solvent (such as de-ionized (DI) water) in a container to form a solution, in accordance with a preferred embodiment of the invention;

FIG. 3 is a picture showing one of the steps of the method in accordance with a preferred embodiment of the invention, in which an ultrasonic processing unit is inserted into a container with the CNT/DI water solution, the container being in ice bath, to apply ultrasound and uniformly disperse CNTs in DI water;

FIG. 4 is a picture showing a carbon fiber preform in accordance with a preferred embodiment of the invention;

FIG. 5 is a picture showing one of the steps of the method in accordance with a preferred embodiment of the invention, in which is the assembly of nanomaterial, solvent and fiber preform is processed in an ultrasonic bath in ice bath to apply ultrasound to incorporate the nanomaterial into the fiber preform;

FIG. 6 is a picture showing the assembly of a nanomaterial (such as CNTs), a solvent (such as DI water) and fibers (such as carbon fiber) preforms in accordance with a preferred embodiment of the invention;

FIG. 7 is a SEM image of carbon nanotubes (CNTs) attached to carbon fibers (CFs) in accordance with a preferred embodiment of the invention;

FIG. 8 is a picture showing a carbon fiber preform with incorporated CNTs exhibiting increased stiffness relative to base material CF preforms, in accordance with a preferred embodiment of the invention;

FIGS. 9a and 9b illustrate, in schematically general terms, a new material in accordance with a preferred embodiment of the invention; with formed heat transfer network consisting of CNTs radially attached to CFs and CNTs bridging the CNTs attached to CFs one to another and with CFs, wherein FIG. 9a is a 3D presentation and FIG. 9b is a frontal 2D presentation.

FIG. 10 illustrates, in schematically general terms, the procedure for impregnating the new CF+CNTs material with matrix in order to obtain new prepreg material, in accordance with a preferred embodiment of the invention;

FIG. 11 is a SEM image of the new material after impregnation with matrix and curing in autoclave in accordance with a preferred embodiment of the invention; where CNTs attached to carbon fibers and impregnated in matrix can be seen as bright pixels;

FIG. 12 is a SEM image of a sample with matrix accumulated against the tool plate, wherein CNTs are bright pixels;

FIGS. 13a and 13b illustrate, in schematically general terms, novel ancillary materials stacking sequence in accordance with a preferred embodiment of the invention, wherein FIG. 13a is a frontal 2D presentation and FIG. 13b is the enlarged detail in circle of FIG. 13a;

FIG. 14 is a graphic showing staking sequence effect in accordance with a preferred embodiment of the invention;

FIG. 15 is a graph showing the curing cycle for matrix system Epon 862/Epicure W, in accordance with a preferred embodiment of the invention.

FIG. 16 is a SEM image showing homogeneous distribution of CNTs throughout the composite material in accordance with a preferred embodiment of the invention.

FIG. 17 is a graphic showing CNT quality impact on nanocomposites thermal conductivity as a function of temperature.

### DETAILED DESCRIPTION

A novel fiber/nanomaterial composite and methods for making thereof will be described hereinafter. Although the invention is described in terms of specific illustrative embodiment(s), it is to be understood that the embodiment(s) described herein are by way of example only and that the scope of the invention is not intended to be limited thereby.

The present invention is directed to methods of incorporating nanomaterial into fibers via incorporation of said nanomaterials into the fiber preforms using ultrasound and iterative steps to form a composite. Optionally, the method is followed by impregnation with a polymer matrix.

While the making and/or using of various embodiments of the present invention are discussed below, it should be appreciated that the present invention provides many applicable inventive concepts that may be embodied in a variety of specific contexts. The specific contexts discussed herein are merely illustrative and are not intended to delimit the scope of the invention.

The aforesaid and other objectives of the present invention are first realized by generally providing a method for the making of a composite of nanomaterials and fibers.

As aforesaid, the method of the invention comprises a step a) of dispersing a given amount of nanomaterials into a solvent to obtain a solution while maintaining the solution at a first constant temperature in order to uniformly disperse the nanomaterial in the solvent.

By “dispersing” it is meant any ways known in the art for uniformly mixing the nanomaterials into the solvent. Sonication is for instance the preferred way to disperse nanotube into water. Nanoclays can be dispersed using agitation.

The solvent is selected in function of the nature of the nanomaterials. In accordance with a preferred embodiment, the solvent may be deionized water, acetone, ethanol, N-methylpyrrolidone (NMP), dimethylformamide (DMF) or mixture thereof. The invention is not limited to the nature of the solvent, the choice thereof depending of the nature of the selected nanomaterials.

In accordance with a preferred embodiment, the nanomaterials may comprise carbon nanotubes (CNTs), graphene, nanoclay, microcapsules or mixture thereof. Preferably, the nanomaterials may be CNTs being single wall carbon nanotubes (SWNTs), double wall carbon nanotubes (DWNTs), multiwall carbon nanotubes (MWNTs), as produced, pretreated, functionalized or any combination thereof. Preferably, the graphene is in the form of graphene nanoplatelets, graphene oxide, graphene flakes or mixture thereof. The invention is not limited to the nature of the nanomaterials.

The method further comprises a step b) of impregnating a dry fiber preform comprising fibers with the solution obtained in step a). This step can be done using different ways know in the art such as by pouring the solution on the preform, or soaking the preform into the solution, or spraying the solution on the preform. More preferably, the solution is poured on the preform.

The method further comprises a step c) of incorporating the nanomaterials into the fiber preform by applying ultrasound to the impregnated fiber preform obtained in step b) at a second constant temperature. This can be achieved via ultrasound that is used all the time in the ultrasound bath in ice bath. The ultrasound is used to dual purpose: i) to maintain nanomaterial dispersed—to prevent reagglomeration of dispersed nanomaterial and ii) to push the nanomaterial inside the fiber preform. In this manner, the filtration effect is overcome and nanomaterial is distributed across the thickness of the fiber preform, in a more or less uniform manner.

The method further comprises a step d) of removing the solvent from the impregnated fiber preform obtained in step c). In accordance with a preferred embodiment, the solvent is removed by heating the impregnated fiber preform, such as using an oven. Other ways of removing a solvent can be used. The temperature will depend on the nature of the solvent. With DI water as solvent, an oven heated at a temperature of about 120° C. can be used.

The method further comprises a step e) of iterating steps a) to d) at least once wherein in iterated step b) the fiber preform is replaced with the impregnated fiber preform obtained in step d) in the previous iteration, until to obtain a desired concentration of nanomaterial incorporated into the composite. The invention is not limited to the number of times the steps are reiterated.

In accordance with a preferred embodiment, the method may further comprise, after step e), a step f) of weighing the composite to determine the exact mass of incorporated nanomaterials when all nanomaterials intended for incorporation in the fiber preform were used during iterating steps e).

In accordance with a preferred embodiment, the method may further comprise, the step of reiterating steps a) to e) at least once with the difference that, in the step b), the composite obtained after the step e) in the previous iteration replaces the impregnated fiber performs.

In accordance with a preferred embodiment, the method may further comprise, the step of combining the nanomaterial-fiber composite with a matrix to form a prepreg or prepreg composite.

The term “prepreg” is known in the art as being fibers pre-impregnated (pre-impregnated=prepreg) with a polymer and partially cured (thermally processed). The prepreg is made to simplify parts manufacturing process and facilitate manipulation during parts manufacturing.

Preferably, the matrix comprises thermoset and/or thermoplastic polymers. More preferably, the matrix comprises epoxy. The invention is not limited to the nature of the polymer.

In accordance with a preferred embodiment, the fibers of the fiber preform comprises carbon fibers, glass fibers, KEVLAR® fibers or mixture thereof. The invention is not limited to the nature of the fibers, and other types of fibers known in the art can be used.

In accordance with a preferred embodiment, the constant temperatures in steps a) and c) are maintained about 0° C. using an ice bath. The term “constant” means that the temperature may slightly vary within a range around the said constant temperature.

The invention is also directed to a composite of nanomaterials and fibers obtained by the method defined herein, the composite comprising nanomaterials with a concentration up to 50 wt. %.

In accordance with a preferred embodiment, the composite has a thermal conductivity from 1.7 to 2 W/mK measured with a temperature ranging from 25 to 125° C.

In accordance with a preferred embodiment, the nanomaterials comprise single wall carbon nanotubes, each carbon fiber defining a longitudinal axis and comprises a plurality of nanotubes surrounding the carbon fiber, and wherein at least a portion of the nanotubes are attached to the fiber and extends from a surface of the fiber with a substantially perpendicular direction to the fiber axis. Preferably, the composite comprises 3 wt % of carbon nanotubes and has a thermal conductivity of about 1.943 W/mK measured at about 125° C.

### Importance of the Nanomaterial Purity, Quality and Distribution.

It can be concluded from available reports that parameters with the highest impact on CNT modified CFRP through thickness thermal conductivity are CNTs purity, quality and distribution. Presence of impurities in CNT material adversely affects determination of CNTs physical properties from both technical and fundamental points of view [H. Rong, et al., Current Applied Physics 2010, 10: 12311235].

To define CNT quality, let's begin with ideal CNT. The ideal CNT would be the one with perfect crystal lattice where hexagons are consisted of carbon atoms only, without any vacancies, inclusions or substitutions. Such carbon atom hexagons would be repeated always in the same manner with respect to the tubule axis while the same helicity would be maintained. Thus defined ideal CNT would be the perfect CNT with respect to heat transfer, i.e. the CNT with the highest quality as there would be no phonon scattering sites. Any CNT with a structure different from the ideal CNT structure would be the CNT with lower quality with respect to heat transfer. CNT quality with respect to heat transfer would degrade with increased number of imperfections in crystal lattice, CNT with the highest number of defects being the CNT with the lowest quality with respect to heat transfer due to the high number of phonon scattering sites.

Therefore, in order to increase CNT modified CFRP thermal conductivity, in particular in the through thickness direction, it is important to employ good quality CNTs. Such CNTs would have lower number of phonon scattering sites. At the same time, in the case of tube-tube contact, CNT coupling intensity would be lower, thus further facilitating heat transfer as phonons would remain on the tube, as opposed to jumping from one tube to another and back in which process energy carried by phonons would be dissipated partially or even completely.

Within the body of CNT structures available, some are better suited for heat transfer than another. Better heat transfer network would be formed from these CNTs than from others.

Another important parameter is the uniformity of CNTs structure. CNTs with the same structure would form better heat transfer network than CNTs that would differ in structure one from another, i.e. if all CNTs would be e.g. (5,5) or (0,0) CNTs, there would be no mismatch in individual CNTs crystal lattice properties. Hence, the phonon boundary scattering would be minimised in case of phonon propagation from one tube to another. In the case of CNT structure different from one tube to another, phonon boundary scattering due to mismatch in crystal lattice properties would contribute to lower thermal conductivity improvement.

Based on above two paragraphs, CNTs most suitable for thermal conductivity improvement would be CNTs with uniform structure well suited for heat transfer.

The highest thermal conductivity was obtained, both numerically and experimentally, for a single SWNT. Any higher form of CNT assembly gave lower thermal conductivity value, decreasing further as the form was becoming more and more complex and approached macroscopic ones. If all CNTs were ideal CNTs as defined above, higher forms thermal conductivity should have been equal to thermal conductivity of the single ideal CNT, as the constituent CNTs would be, SWNT, DWNT or MWNT, disregarding the number of CNTs involved or mechanical coupling as all phonons would remain on tube. However, degradation in thermal conductivity with increasing number of building blocks—CNTs—provides evidence of imperfections presence and intertube coupling thereafter. Hence, to emulate thermal conductivity of a single CNT, it is necessary to disperse CNTs.

To disperse CNT higher forms like bundles and separate CNTs one from another, sonication was giving the best results. However, another issue appeared in polymer composite manufacturing process—agglomeration of dispersed CNTs. The highest CNT weight content in a composite obtained with homogeneous CNT distribution—i.e. no agglomerations were observed—was achieved via layer-by layer LBL approach.

In order to avoid unnecessary intertube coupling, as long as effective heat transfer network of individual CNTs is maintained in a CFRP, CNTs need to be well dispersed. Reviewed results suggest that sonication and LBL method would be the most effective means towards this goal both for polymer composites and CFRP. However, the invention cannot be limited to the way the nanomaterials are dispersed since this depends on the nature of the nanomaterial and/or solvent. For instance, nanoclay will be preferably dispersed using agitation in the solvent, whereas sonication is preferably used to disperse nanotubes.

Reviewed literature provides insight in the potential of CNTs as a filler of choice for thermal interface materials and improvement of composite materials employed in areas where efficient heat dissipation is a valuable property. Carbon nanotubes are best suited to improve both electrical and thermal conductivity even as the former was not investigated. However, realization of such potential depends on several factors. Factors considered the most important for thermal conductivity improvement are CNT quality and CNTs dispersion homogeneity.

To demonstrate CNT quality importance for epoxy composites thermal conductivity, different quality CNTs were selected.

In order to obtain composite material of intended properties, it is important to select appropriate materials and manufacturing process. The most successful approach thus far was reported by Mathur et al. [International Journal of Nanotechnology, 2012, 9: 1040-1049]. Achieved through thickness thermal conductivity was 2.61 W/mK, the improvement of ˜44% over the reference material thermal conductivity of 1.82 W/mK. Bearing the above in mind, the present invention is preferably to develop a multifunctional high performance hybrid composite material with heat dissipation properties improvement beyond the current state of the art. To this extent carbon fibers, carbon nanotubes and epoxy resin may be utilized.

In order to resolve filtering effect appearing when CNTs are added to CFRP, manufacturing process was suitably tailored. CNTs shall be first dispersed and incorporated into CF preforms using ultrasound, followed by impregnation by resin and manufacturing of prepreg, followed by laminate curing in autoclave.

Filtering effect is as well the reason behind the chosen thin, unidirectional carbon fiber fabric, made of 3 k tows giving low specific weight per m². This material is used in aerospace industry, one of industries targeted with this research. The low specific mass and thickness are facilitating homogeneous distribution of CNTs inside the CF preform. The thin CF preform would emulate the substrate on which CNTs are to be attached, followed by impregnation with resin. Described process would be an emulation of highly successful LBL process, employed on CNTs and polymer, taking advantage of benefits rendered by it—CNTs well distributed throughout composite via thin layers.

### EXAMPLES

The following examples are for Carbon nanotubes (CNTs) as nanomaterial, carbon fibers (CFs) as fibers and epoxy as polymer for the making of the composite. It is to be understood that the invention should not be limited to these specific examples.

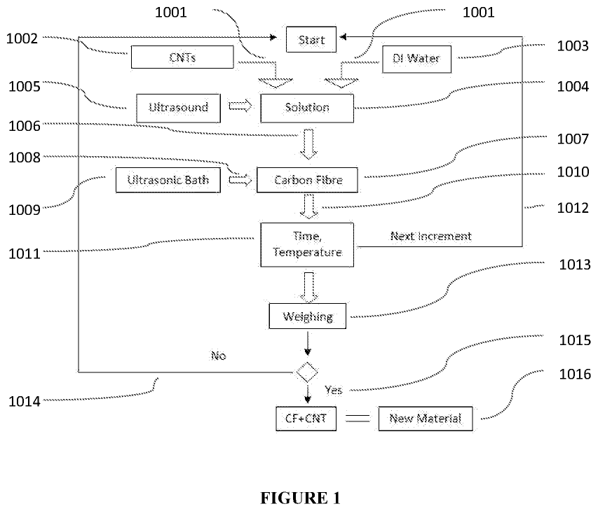

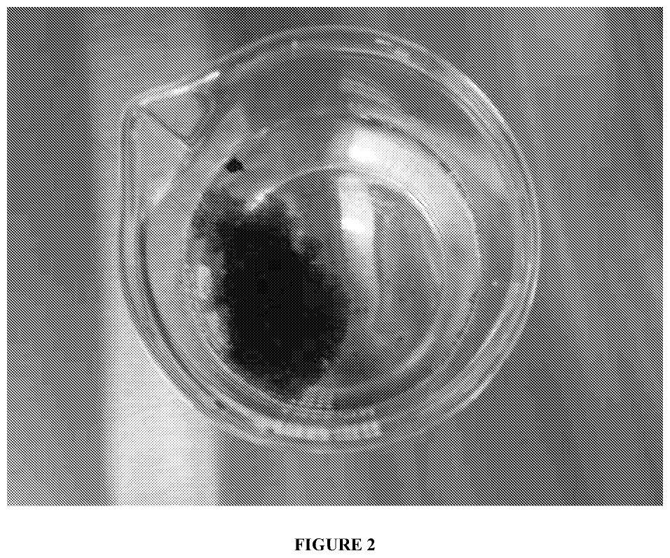

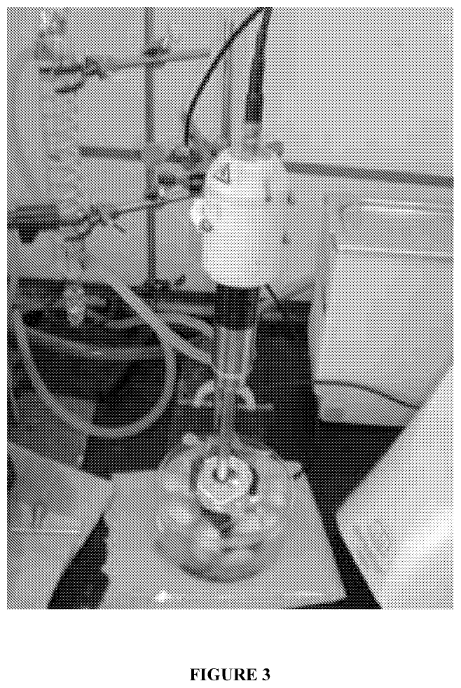

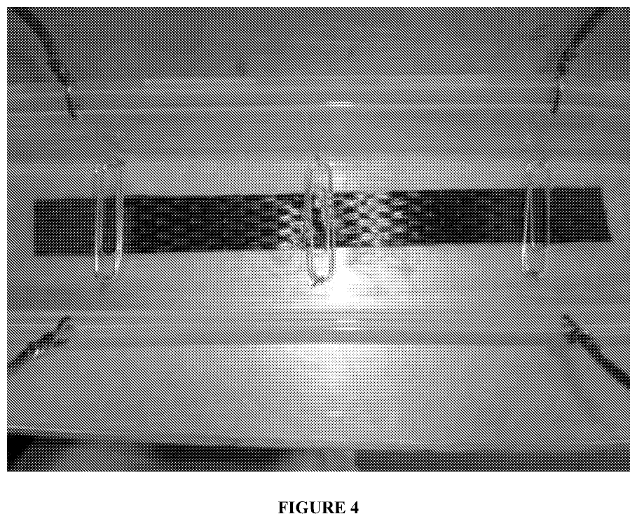

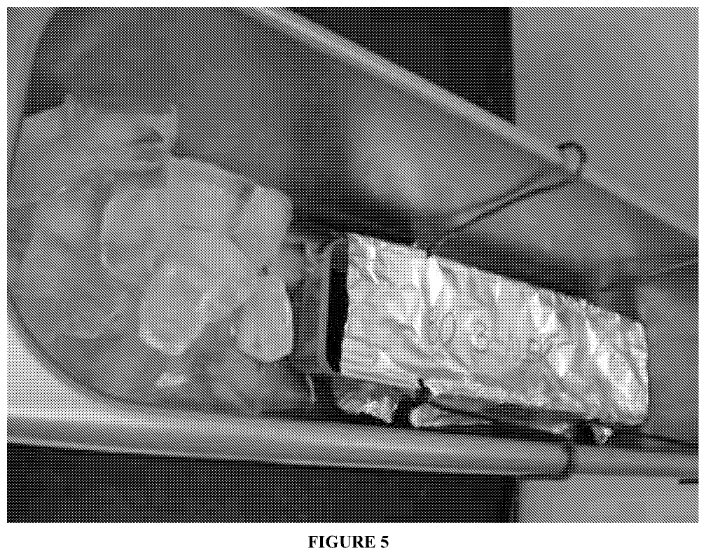

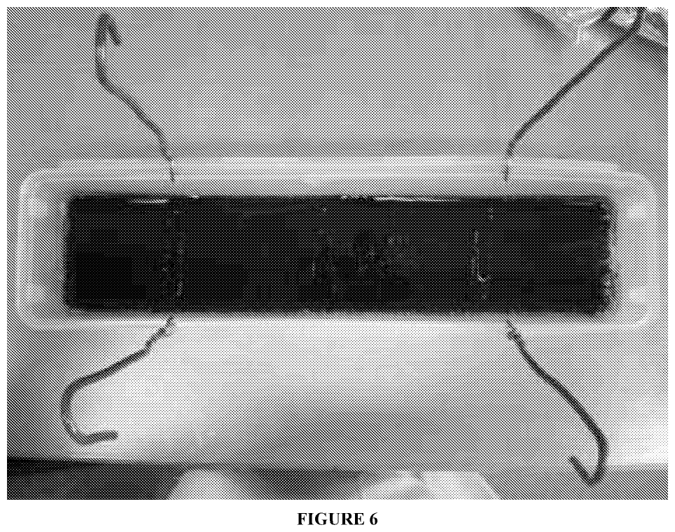

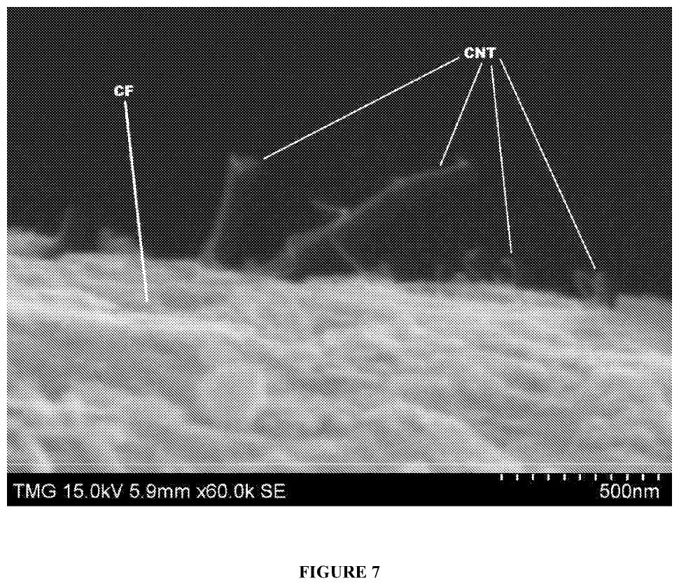

Referring to FIG. 1, a method for the making of the composite in accordance with a preferred embodiment of the invention is illustrated. The method generally comprises the steps of:
mixing (1001) CNTs (1002) and de-ionized (DI) water (1003) as a solvent in a container to form a solution (1004) (see FIG. 2);
applying an ultrasonic processing unit (1005) in ice bath to uniformly disperse the CNTs (1002) in DI water (1003) (see FIG. 3);
pouring (1006) thus obtained solution over the carbon fiber preforms (1007) (see FIG. 4);
processing (1008) in an ultrasonic bath (1009) in ice bath (see FIG. 5) the assembly of CNTs (1002). DI water (1003) and carbon fiber preforms (1007) (see FIG. 6) by applying ultrasound to incorporate CNTs (1002) into carbon fiber preforms (1007);
putting (1010) the carbon fiber preforms with incorporated CNTs (see FIG. 7) into an oven;
removing (1011) the solvent by holding the carbon fiber preforms with incorporated CNTs inside the oven at about 120° C. for a minimum of about 24 hours;
adding (1012) the next incremental weight of CNTs to the carbon fiber preforms with incorporated CNTs by repeating steps (1001) to (1011) with the difference in the step (1006) that the carbon fiber preforms with incorporated CNTs obtained after the step (1011) in the previous iteration would replace carbon fiber performs (1007);
weighing (1013) the carbon fiber preforms with incorporated CNTs to determine the exact mass of incorporated CNTs when all CNTs intended for incorporation in the carbon fiber preform (1007) were used;
repeating (1014) steps (1001) to (1013) by mixing (1001) the DI water (1003) with the mass of CNTs (1002) which is the difference between the required one and the one incorporated in the CF preform as determined via weighing if the mass of incorporated CNTs did not satisfy the initial requirement (e.g. 2 wt %), with the difference in the step (1006) that the carbon fiber preforms with incorporated CNTs obtained after the step (1013) in the previous iteration would replace carbon fiber preforms (1007) and with the exclusion of the step (1012); obtaining (1015) the new material (1016) (see FIG. 7, FIG. 8) with incorporated designated mass of CNTs as determined by weighing (1013) that is satisfying the initial requirement.

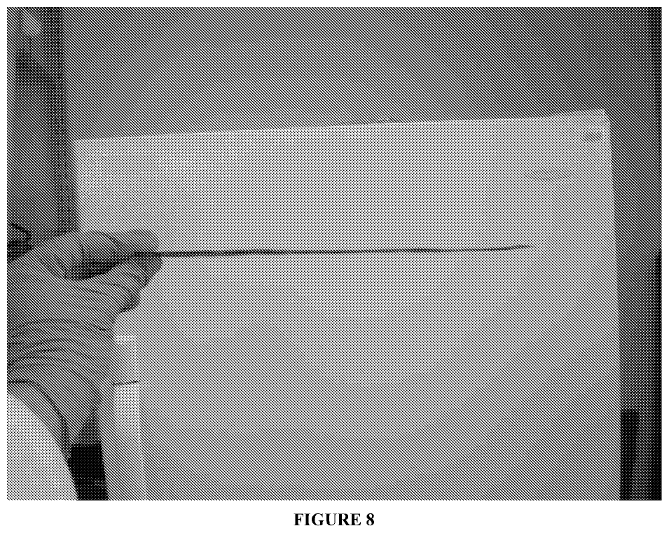

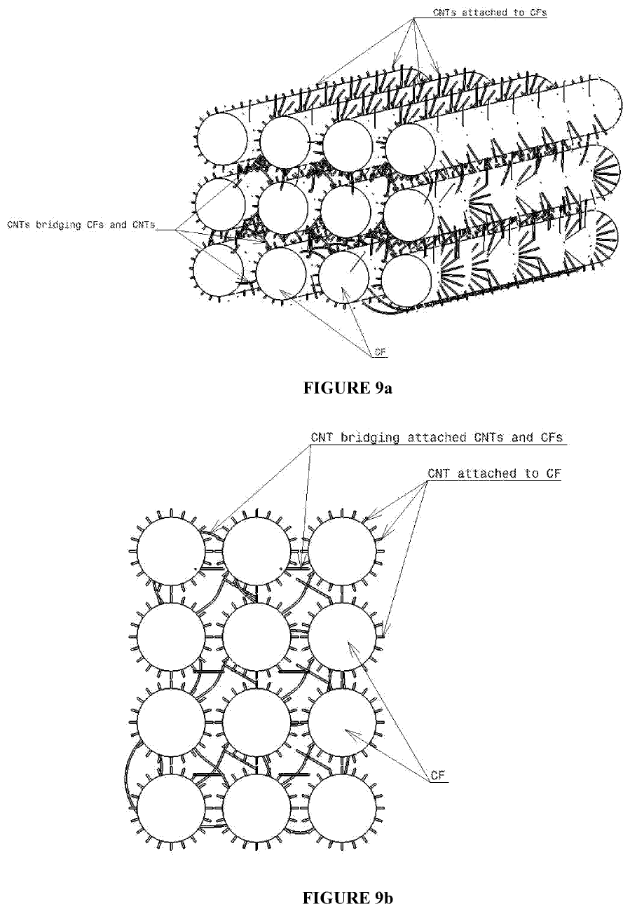

The mechanism of incorporation of CNTs into the CF preform is as follows. First, CNTs get attached to CFs (FIG. 7). Once CNTs are attached to CFs, other CNTs get loosely attached to CNTs attached to CFs, bridging CFs and CNTs attached to CFs, thus forming the heat transfer network (FIG. 9).

It is reasonable to expect that described procedure used to incorporate CNTs into CFs fabric can be utilized with other materials. In this case other materials could be either different nanomaterial, different fiber like glass or KEVLAR® fiber, different form of fabric or a different solvent. Fibers could be in the form of any fabric weave, tow or individual fibers.

Different nanomaterials that could be used are different CNTs, graphene, nanoclay and even microcapsules. CNTs could be SW, DW or MWNTs, as produced, treated (acidic, centrifuge or heat treatment), functionalised or any their combination. Graphene could be in the form of graphene nanoplatelets, graphene oxide, graphene flakes or any other one like graphene with CNTs grown on them, as produced, treated (acidic, centrifuge or heat treatment), functionalised or any their combination. Mentioned nanomaterials could be combined one with another in any manner, for example any (or all) variety of graphene mentioned with any variety (or all) of CNT mentioned or anything in between. Any nanomaterial or combination mentioned could be incorporated in any carbon fiber or glass fiber or KEVLAR® fiber form. To this purpose, different solvents could be used in addition to DI water, like acetone, ethanol, N-methylpyrrolidone (NMP), dimethylformamide (DMF) or others.

“Solvent”, as referred to herein is any solvent like DI water, acetone, ethanol, N-methylpyrrolidone (NMP), dimethylformamide (DMF) or others. DI water is the preferred solvent to be used as it has higher boiling temperature than other solvents and least possibility of chemical interaction with either nanomaterials such as CNTs or fibers such as CFs.

“Ice bath”, as referred to herein is a container containing ice or mix of ice and water thus maintaining temperature within the container at 0° C. or in the close vicinity of this temperature. The ice bath container is, at the minimum, large enough to allow for a smaller container containing either solution of CNTs and DI water or assembly of solution of CNTs and DI water and CFs preforms to be immerged up to the upper rim.

The ice bath is applied to maintain processing temperature, thus ensuring process repeatability and preventing/slowing solvent evaporation.

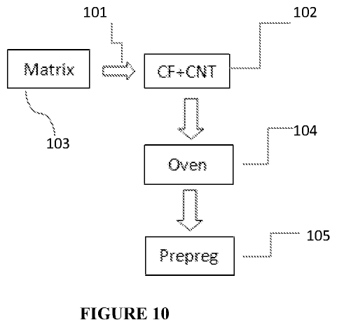

Referring to FIG. 10, new prepreg material was created by (101) impregnating (102) new (1016) CF+CNTs material obtained after the step (1015) with (103) epoxy matrix Epon 8621W (the matrix); (104) partially curing the epoxy matrix inside an oven at 60° C. for 30 minutes; (105) obtaining the prepreg with 15.6% cured matrix.

Epoxy matrix Epon 8621W, according to the present invention includes, but is not limited to, epoxy resin based matrixes, and other matrixes generally referred to as “thermoset” matrixes. Other matrixes, generally referred to as “thermoplastic” matrixes can be used as well. In case where matrix other than Epon 8621W is used, the prepreg preparation procedure shall be altered to apply partial curing cycle suitable to the matrix used.

The matrix can be applied using manual or machine assisted techniques, without any exclusion or limitation.

Thus obtained prepreg layers could be either used immediately to create a part or stored in the freezer.

The prepreg would be cut to desired dimensions, stacked up on the tool plate and cured in the autoclave. Other manufacturing processes can be employed as well, without any exclusion or limitation.

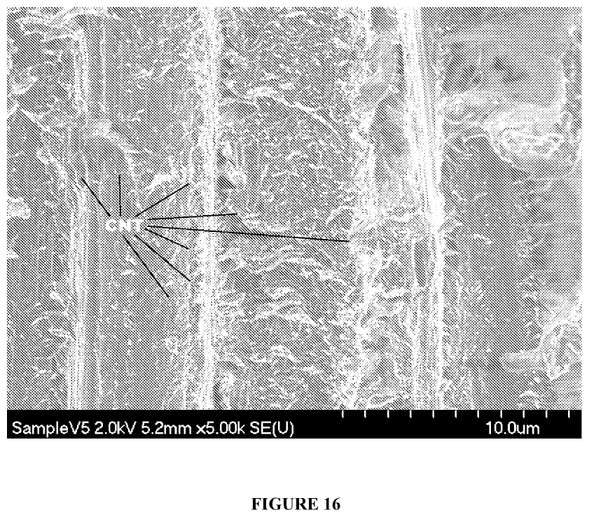

Resultant material (see FIG. 11, FIG. 16) contains well dispersed and incorporated CNTs (bright pixels) forming the heat transfer network. In the same time fracture surface exhibits features of a tough material fracture surface. This is an improvement over standard brittleness of epoxy matrix.

### Example 1

This example serves to illustrate how the CNTs were incorporated into the composite material and how they improved nanocomposite thermal conductivity.

Materials with good thermal conductivity can be used in applications where heat dissipation is required.

The present example is focused on the effect of incorporation of CNTs in a CFRP in an attempt to achieve improved thermal conductivity of a composite constituting of SWNT, PAN based carbon fibres and epoxy matrix.

### Materials

Raw SWNTs were purchased from Unidym, Inc. (Houston, Tex.). SWNTs were produced by HiPCO process. HiPCO CNTs were chosen as they promised the highest improvement of thermal conductivity [M. J. Biercuk, M. C. Llaguno, M. Radosavljevic, J. K. Hyun, A. T. Johnson, J. E. Fischer; Applied Physic Letters 2002, 80: 2767-2769]. This commercial material contains 16.5% TGA residuals (as Fe). Selected matrix is the system obtained by combination of bisphenol-F epoxy resin Epon 862 and aromatic amine curing agent Epicure W. This system has very long working life at room temperature and high operational temperature when cured. Low room temperature viscosity allows better manufacturing process, hand lay-up utilised in samples manufacturing was facilitated by this material property. This system was purchased from Hexion Specialty Chemicals, Inc.

The matrix properties are presented in Table 1.

| Property | Value | |
|---|---|---|
| Room temperature viscosity | ~2.2 | Pas |
| Density | 1174.5 | kg/m³ |
| Working life | >20 | h |
| Moisture absorption | 2-2.5 | wt % |
| Operating temperature | 170° | C. |

Carbon fibre fabric HexForce® G0947 D 1040 TCT is a carbon fabric produced by Hexcel from high strength PAN based carbon fibres. Warp material are 3 k yarns made utilising HTA 5131 carbon fibres. The fibre density is 1760 kg/m³. Weft yarns EC5 5.5×2 are made utilising glass fibres. Fabric content is 97% warp and 3% weft. Material thickness is 0.16 mm. Material nominal weight is 160 g/m².

Solvent used was DI water. Perforated release film resistant to high temperatures of up to 200° C. was used. Felts bleeder and breather resistant to high temperatures of up to 200° C. were used. Curing tool used was aluminium tool plate. Vacuum bag used was made of polymer alloys resistant to high temperatures of up to 200° C. Vacuum bag sealant tape—two side sealant tape used was sealant tape resistant to high temperatures of up to 200° C.

### Production of Composite Material

Composites in this example were produced with 3 wt % of SWNTs. The concentration of SWNTs was determined relatively to the dry carbon fibre preform.

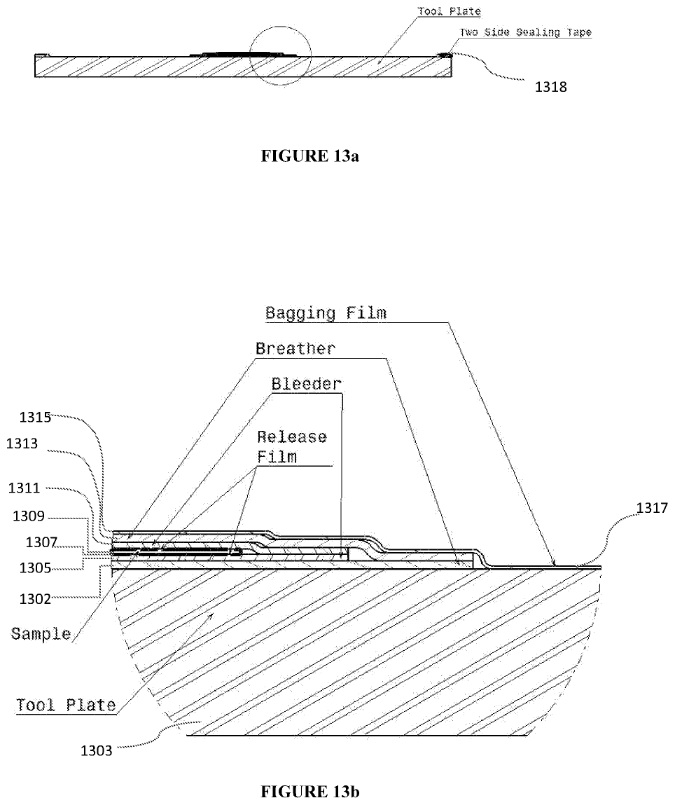

For the preparation of FRP composite material the method used was comprising the steps of a) incorporating SWNTs into the carbon fibre preforms (see FIG. 1). The preforms were obtained by cutting carbon fibres fabric to dimensions 0.22×0.022 m.; b) impregnation of composite material obtained in step a) with epoxy matrix using hand layup technique; c) partially curing the material obtained in step b in oven for 30 min at 60° C. in order to obtain a prepreg; d) preparing [0₂] samples for autoclave curing using hand layup technique by stacking two prepreg layers on the tool plate. During the stacking, breather, bleeder and release film were applied both above and under the sample, release film being next to the sample and breather being against both the tool plate below and the bagging film above the sample. The bleeder was between release film and breather layers (see FIG. 13); e) curing thus prepared composite in an autoclave at 177° C. for 150 min. Pressure (41.4 kPa) and vacuum (84.6 kPa) were applied to help compact the laminate, suppress voids and facilitate gasses extraction (see FIG. 15).

### Step a.

The CF preform was cut to dimensions 0.22×0.022 m. The preform was weighed using balance with precision of 0.0001 g. In order to retain CFs preform rectangular form and hold CFs together, both preform ends were fixed using epoxy matrix that cures at room temperature.

SWNT mass was measured using the same balance as for the CF preform.

Incorporation of SWNTs into the carbon fibre preform was completed per method schematically shown in FIG. 1. For the first iteration, 1 wt % of measured CF preform was measured and used. Measured CNTs were mixed in a glass beaker with 120 ml of DI water (see FIG. 2). CNTs were dispersed in DI water with the aid of ultrasound applied for 30 min using a high power cuphorn ultrasonic processor—the power switch was set at the middle of the range. During sonication, the beaker was held in ice bath in order to maintain the processing temperature constant. Thus obtained solution was used to impregnate the CF preform. Ultrasound was applied to the impregnated CF preform using an ultrasonic bath while the temperature was maintained constant using ice bath. When the solution became clear, the solvent was removed from the impregnated preform by holding the impregnated preform taken out of the solution in an oven at 120° C. for 24 hours. This was the first iteration of addition of CNTs in the CF preform. Another 1 wt % of CNTs was measured. The measured CNTs were mixed in a glass beaker with 120 ml of DI water and the above described process was repeated. The difference was that in this iteration, composite material comprising CF and CNTs, obtained after the previous iteration was used as CF preform. When the current iteration was completed the third iteration was done with another 1 wt % of CNTs. In this third iteration, CNT/CF composite obtained after the second iteration was used as CF preform. When the current iteration was completed, the composite material comprising CF and CNTs was weighed using the same balance as above. The result showed that 2.8 wt % of CNTs was incorporated into the CF preform. The difference of 0.2 wt % between the desired 3 wt % and obtained 2.8 wt % of CNTs incorporated in the CF preform was measured and mixed with 120 ml of DI water to form solution with the aid of ultrasound as described above. CNT/CF composite obtained after the third iteration was impregnated with the obtained solution. Ultrasound was applied to the impregnated CF preform using an ultrasonic bath while the temperature was maintained constant using ice bath. When the solution became clear, the solvent was removed from the impregnated preform by holding the impregnated preform taken out of the solution in an oven at 120° C. for 24 hours. When the current iteration was completed, the composite material comprising CF and CNTs was weighed using the same balance as above. The result showed that 3 wt % of CNTs was incorporated into the CF preform.

### Step b)

Impregnation of impregnated CF preform obtained in step a) with epoxy matrix system Epon 8621W was achieved using hand layup technique.

### Step c)

The epoxy matrix was partially cured inside an oven at 60° C. for 30 minutes thus giving prepreg with 15.6% cured matrix.

### Step d)

Composite parts [0₂] were prepared for autoclave curing using hand layup technique by stacking two prepreg layers obtained in step c) on the tool plate. During the stacking, ancillary materials—breather, bleeder and release film—were applied both above and under the sample, release film being next to the sample and breather being against both the tool plate below and the bagging film above the sample. The bleeder was between release film and breather layers (see FIG. 13);

### Step e)

The final part was obtained by curing composite prepared in step d) in an autoclave at 177° C. for 150 min. Pressure (41.4 kPa) and vacuum (84.6 kPa) were applied to help compact the laminate, suppress voids and facilitate gasses extraction (see FIG. 15).

From the composite parts obtained in step e) coupons for thermal diffusivity measurement were cut using a cutting knife. The size of the coupons was 12.7×12.7 mm. The thickness is recommended as a function of expected thermal diffusivity. For materials with low thermal diffusivity, coupon thickness should be 1 mm or less with the upper and lower surface as flat and parallel as possible. Samples flatness as well as top and bottom surfaces parallelism were assured via tooling and stacking sequence. The thickness was determined as an average of five values measured at coupon corners and the centre using micrometer. These three dimensions provided for the volume of the coupon. A coupon density is determined by dividing the measured mass of the coupon by the calculated volume of the coupon. Density is a parameter required to calculate thermal conductivity per equation (1).

κ=α*ρ*Cp (1)

Where symbols denote:

κ—thermal conductivity

α—thermal diffusivity

ρ—density

Cp—specific heat.

Each of the above properties is determined independently of one another prior to combining them into equation (1). While density is considered to be constant in the measured temperature range, thermal diffusivity and specific heat are temperature dependent, thus providing temperature dependent thermal conductivity.

Three measurements are taken into account to determine the specific heat of a sample. One is the baseline measurement, the second one is the reference material measurement and the third one is the sample measurement. The software provided by DSC manufacturer is used to calculate Cp for each sample utilizing the above three measurements.

All samples measurements, baseline measurement and reference measurement were completed per following procedure:

1. Equilibrate at 0° C.

2. Isothermal for 10 min.

3. Ramp 20° C./min to 140° C.

4. Equilibrate at 140° C.

5. Isothermal for 10 min.

Samples thermal diffusivity was established with the flash method according to standards ASTM E-1461, DIM EN 821 and DIN 30905 [Operating instructions LFA 447™ Nanoflash—Netzsch]. Measurement was competed at three points: 25° C., 75° C. and 125° C.

Thus obtained values were combined to obtain thermal conductivity (DR3) per EQ. 1. The results are presented in table 2:

TABLE 2
Thermal conductivity for Type C and DR samples.

| | κ [w/mK] | | | κ - Relative Increase [%] | | |
|---|---|---|---|---|---|---|
| T [° C.] | 25 | 75 | 125 | 25 | 75 | 125 |
| Sample | | | | | | |
| Type C | 0.711 | 0.978 | 1.127 | | | |
| DR3 | 1.711 | 1.840 | 1.942 | 140.6 | 88.1 | 72.3 |

The obtained thermal conductivity presents increase of 140% at 25° C. over 88% at 75° C. to 72% at 125° C. over coupons made from composite material (Type C) containing CF and matrix produced via the above described method and materials and not containing CNTs. Thermal conductivity of (Type C) sample was determined in the same manner as for the (DR3) sample. The reason for the difference in thermal conductivities between the (Type C) and (DR3) parts is presence of CNs in part (DR3). The CNTs in DR3 sample form heat transfer network thus increasing thermal conductivity of the composite material.

Compared to the state of the art [R. B. Mathur, B. P. Singh, P. K. Tiwari, T. K. Gupta; International Journal of Nanotechnology 2012, 9: 1040-1049], obtained thermal conductivity value is lower. However, it should be noted that materials used to produce composite material in the course of these two studies were different, both carbon fibres and epoxy matrix. Hence the difference in reference material thermal conductivity, 0.711 W/mK at 25° C. for the material used in this research vs. 1.82 W/mK obtained for the material used in study by Mathur et al. On the other side, thermal conductivity relative increase obtained in this study is by far exceeding ˜44% obtained in study by Mathur et al. Another difference between the two studies is the concentration of CNTs. This study achieved the above result with 3 wt % of CNTs while in the study by Mathur et al. the highest conductivities were measured on preforms with 11.68 wt % of CNTs.

Applicant has shown that the above described method improves nanocomposite part thermal conductivity.

A practical use of the method to incorporate CNTs into CFRPs described above has been demonstrated in the example. The application of ultrasound and iteration steps to incorporate CNTs into the dry CF preform allows for homogeneous CNTs distribution throughout the sample, forms effective heat transfer network and eliminates filtering effect thus significantly increasing nanocomposite part thermal conductivity.

### The Effect of Ancillary Materials Stacking Sequence

The invention is further directed to an ancillary material stacking sequence comprising the following sequences:
a) at least one first breather placed against a curing tool;
b) at least one first bleeder placed on the first breather(s);
c) a first release film placed on the first bleeder(s);
d) a composite comprising nanomaterials and fibers placed on the release film;
e) a second release film placed on the composite;
f) at least one second bleeder placed on the second release film;
g) at least one second breather placed on the second bleeder(s); and
h) a vacuum bag sealed on the second breather(s) and the curing tool, using a sealing tape.

Preferably, in sequence d), the composite comprising nanomaterials and fibers is the composite of the invention as defined herein.

The invention is also directed to a method for the making of an ancillary material stacking sequence comprising the following steps:
a) placing at least one first breather against a curing tool;
b) placing at least one first bleeder on the first breather(s);
c) placing a first release film on the bleeder(s);
d) placing a composite comprising nanomaterials and fibers on the release film;
e) placing a second release film on the composite;
f) placing at least one second bleeder on the second release film;
g) placing at least one second breather on the second bleeder(s); and
h) sealing a vacuum bag on the second breather and the curing tool.

The following examples are for the specific ancillary materials and the specific stacking sequence used for a specific application—to increase composite thermal conductivity. It is to be understood that the invention should not be limited to these specific ancillary materials, the specific stacking sequence and the specific application as it can be extended to other transport properties (such as, without limitation to it, electrical conductivity) improvement of which is attempted via incorporation of CNTs, (SW, DW or MWNTs), other nanomaterials like graphene (in the form of graphene nanoplatelets, graphene oxide, graphene flakes or any other one), any combination of any of the mentioned forms of CNTs and/or graphene forms, including CNTs grown on any of the mentioned forms of graphene.

The application of ancillary materials both below and above the part being produced can be applied for all composite materials manufacturing processes. This invention can be applied to achieve as well better general properties as those skilled in art can appreciate.

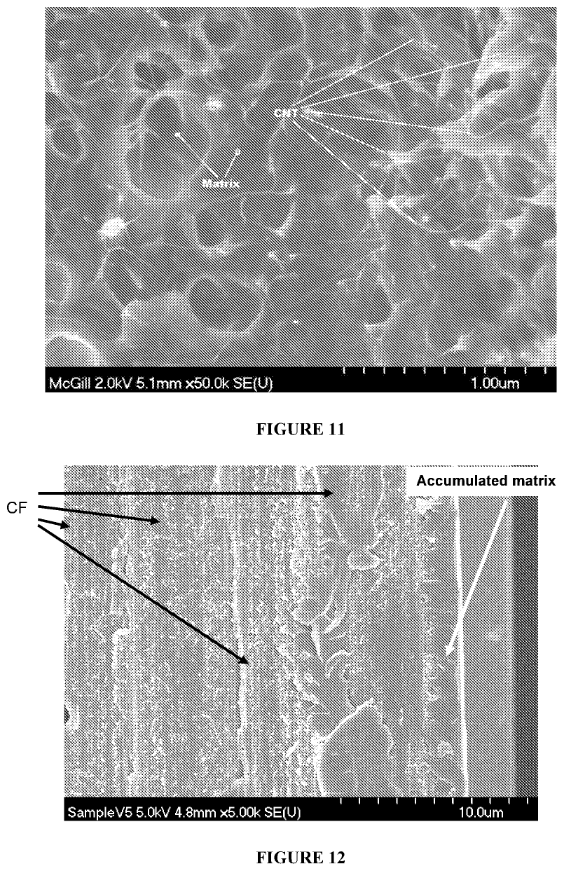

During the initial stage of preliminary research, the standard stacking sequence was used. Tool plate would be covered by a thin film of a release agent. On such prepared tool plate, a sample would be put. Release film would cover the sample, followed by bleeder and breather. Bagging film would complete the stacking sequence, when samples were produced and examined under SEM, the stacking sequence was modified. During SEM investigation of a sample stacked up for autoclave curing in the standard manner described above, an accumulation of matrix was observed on the sample surface that was against the tool plate during the curing process (see FIG. 12).

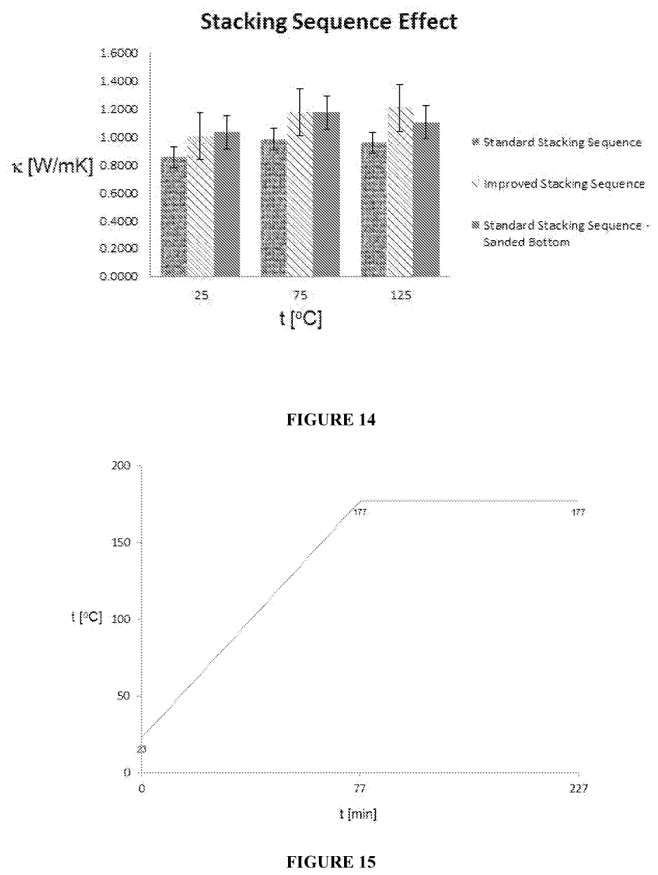

This layer of matrix was acting as an insulating layer. This was confirmed when sending it off increased thermal conductivity. Removal of matrix from the bottom side increased thermal conductivity by approximately 20% at 25° C. and 75° C. On the other side, the stacking sequence above the sample was the optimum configuration to exploit CNT effect on thermal conductivity, as even the minimum intervention on the top side was reducing thermal conductivity of the coupon. This stacking sequence allowed for CNTs to be on the surface of the sample, thus benefiting the through thickness thermal conductivity in the best possible manner. Hence, in order to eliminate matrix accumulation against the tool plate and formation of insulating layer, the standard stacking sequence was altered to apply release film, bleeder and breather both below and above the sample. Release film was next to the sample and breather was against both the tool plate below and the bagging film above the sample. The bleeder was between release film and the breather layers (see FIG. 13). TC measurement gave results (ISS) comparable to the samples with sanded bottom (SB) (see Table 3 and FIG. 14).

TABLE 3
Thermal conductivity of samples made using standard
stacking sequence and improved stacking sequence:

| | κ [w/mK] | | | κ- Relative Increase [%] | | |
|---|---|---|---|---|---|---|
| t [° C.] | 25 | 75 | 125 | 25 | 75 | 125 |
| Sample | | | | | | |
| AP | 0.854 ± 0.070 | 0.983 ± 0.080 | 0.957 ± 0.076 | | | |
| SB | 1.034 ± 0.125 | 1.175 ± 0.128 | 1.104 ± 0.104 | 21.1 | 19.5 | 15.4 |
| ISS | 1.008 ± 0.153 | 1.174 ± 0.173 | 1.209 ± 0.177 | 18.0 | 19.5 | 26.3 |

The following examples are for bleeder and breather. It should be understood that the invention should not be limited to these specific examples.

The novelty of the ancillary sequence is placing breather and bleeder between the release film and curing tool in order to eliminate accumulated matrix against the tool plate. This in the same time exposes (brings to the surface, creates nanomaterial rich surface, eliminates nanomaterial starved surface) nanomaterial (for example CNTs) and maximizes their contribution to the thermal conductivity enhancement. The same, due to the similar nature of the phenomena, can be applied to increase composite materials other transport properties, including, but not limited to, electrical conductivity.

In the example disclosed herein, the ancillary material stacking sequence improvement was used in autoclave curing and hand layup technique. It can be used in other composite materials production processes, manual or automated, to eliminate voids and resin rich areas in produced parts. This would be achieved as the vacuum would be better distributed over the lower area of the composite part thus facilitating excess resin outflow.

Referring to FIGS. 13a and 13b, a method for the arranging of ancillary materials in accordance with a preferred embodiment of the invention is illustrated. The method generally comprises the steps of:
placing (1301) a breather (1302) against a curing tool (1303);
placing (1304) a first bleeder (1305) on the breather (1302);
placing (1306) a first release film (1307) on the first bleeder (1305);
placing (1308) a composite part (1309) on the first release film (1307);
placing (1310) a second release film (1311) on the composite part (1309);
placing (1312) a second bleeder (1313) on the release film (1311); and
placing (1314) a second breather (1315) on the second bleeder (1313); and
sealing (1316) vacuum bag (1317) on the second breather (1315) and the curing tool (1303). A vacuum bag sealant tape (1318) can be used.
   Breather, according to the preferred embodiment of the invention, includes, but is not limited to, material which function is to distribute vacuum over part area. Such material can be made of, including but not limited to, woven fabric, felts and woven glass.

Curing tool, according to the preferred embodiment of the invention, includes, but is not limited to, object that is used for support during layup and cure. Such object can be made of, including but not limited to, aluminium, steel, invar, electroformed nickel, graphite/epoxy, elastomer, bulk graphite and ceramics.

Bleeder, according to the preferred embodiment of the invention, includes, but is not limited to, material which function is to absorb excess resin. Such material can be made of, including but not limited to, woven fabric, felts and woven glass.

Release film, according to the preferred embodiment of the invention, includes, but is not limited to, material which function is to release composite part from tool. Such material can be made of, including but not limited to, fluorinated ethylene propylene, halohydrocarbon polymers, PTFE, polyimides, polyamides, polytetramethylene, or terephthalamide.

Vacuum bag, according to the preferred embodiment of the invention, includes, but is not limited to, material which function is to envelope part and tool for vacuum. Such material can be made of, including but not limited to, nylons, polymer alloys, some metals and silicone rubbers.

Vacuum bag sealant tape, according to the preferred embodiment of the invention, includes, but is not limited to, material which function is to seal the vacuum bag via adhesion both to the vacuum bag and the curing tool.

### EXAMPLES

This example serves to illustrate how the ancillary materials improved stacking sequence was come to and how it can be applied to improve nanocomposite thermal conductivity.

Materials with good thermal conductivity can be used in applications where heat dissipation is required.

The present example is focused on the effect of application of improved stacking sequence in an attempt to achieve improved thermal conductivity of a composite constituting of SWNT, PAN based carbon fibres and epoxy matrix.

### Materials

Purified SWNTs were purchased from Unidym, Inc. (Houston, Tex.). SWNTs were produced by HiPCO process. HiPCO CNTs were chosen as they promised the highest improvement of thermal conductivity [M. J. Biercuk, M. C. Llaguno, M. Radosavljevic, J. K. Hyun, A. T. Johnson, J. E. Fischer; Applied Physic Letters 2002, 80: 2767-2769]. This commercial material contains 8% TGA residuals (as Fe). Selected matrix is the system obtained by combination of bisphenol-F epoxy resin Epon 862 and aromatic amine curing agent Epicure W. This system has very long working life at room temperature and high operational temperature when cured. Low room temperature viscosity allows better manufacturing process, hand lay-up utilised in samples manufacturing was facilitated by this material property. This system was purchased from Hexion Specialty Chemicals, Inc. The matrix properties are presented in Table 1 before.

Carbon fibre used was a carbon fibre fabric GA 090 produced by Hexcel from 12 k yarns. Material nominal weight is 305 g/m². Solvent used was DI water. Perforated release film resistant to high temperatures of up to 200° C. was used. Felts bleeder and breather resistant to high temperatures of up to 200° C. were used. Curing tool used was aluminium tool plate. Vacuum bag used was made of polymer alloys resistant to high temperatures of up to 200° C. Vacuum bag sealant tape—two side sealant tape used was sealant tape resistant to high temperatures of up to 200° C.

### Production of Composite Material

Composites in this example were produced with 1 wt % of SWNTs. The concentration of SWNTs was determined relatively to the dry carbon fibre preform.

For the preparation of FRP composite material the method used was comprising the steps of a) incorporating SWNTs into the carbon fibre preforms (see FIG. 1). The preforms were obtained by cutting carbon fibres fabric to dimensions 0.22×0.022 m.; b) impregnation of composite material obtained in step a) with epoxy matrix using hand layup technique; c) partially curing the material obtained in step b in oven for 30 min at 60° C. in order to obtain a prepreg; d) preparing [0₂] samples for autoclave curing using hand layup technique by stacking two prepreg layers on the tool plate.

During the stacking, breather, bleeder and release film were applied both above and under the sample, release film being next to the sample and breather being against both the tool plate below and the bagging film above the sample. The bleeder was between release film and breather layers (see FIG. 13); e) curing thus prepared composite in an autoclave at 177° C. for 150 min. Pressure (41.4 kPa) and vacuum (84.6 kPa) were applied to help compact the laminate, suppress voids and facilitate gasses extraction (see FIG. 15).

Step a):

The CF preform was cut to dimensions 0.22×0.022 m. The preform was weighed using balance with precision of 0.0001 g. In order to retain CFs preform rectangular form and hold CFs together, ACCO stainless steel paper clips were put on both sides of the preform and tied together using stainless steel wire at both ends and in the middle (see FIG. 4). SWNT mass was measured using the same balance.

Incorporation of SWNTs into the carbon fibre preform was completed per method schematically shown in FIG. 1. For the first iteration, 0.5 wt % of measured CF preform was measured and used. Measured CNTs were mixed in a glass beaker with 120 ml of DI water (see FIG. 2). CNTs were dispersed in DI water with the aid of ultrasound applied for 30 min using a high power cuphorn ultrasonic processor—the power switch was set at the middle of the range. During sonication, the beaker was held in ice bath in order to maintain the processing temperature constant. Thus obtained solution was used to impregnate the CF preform. Ultrasound was applied to the impregnated CF preform using an ultrasonic bath while the temperature was maintained constant using ice bath. When the solution became clear, the solvent was removed from the impregnated preform by holding the impregnated preform taken out of the solution in an oven at 120° C. for 24 hours. This was the first iteration of addition of CNTs in the CF preform. Another 0.5 wt. % of CNTs was measured. The measured CNTs were mixed in a glass beaker with 120 ml of DI water and the above described process was repeated. The difference was that in this iteration, composite material comprising CF and CNTs, obtained after the previous iteration was used as CF preform. When the current iteration was completed, the composite material comprising CF and CNTs was weighed using the same balance as above. The result showed that 1 wt. % of CNTs was incorporated into the CF preform.

Step b):

Impregnation of impregnated CF preform obtained in step a) with epoxy matrix system Epon 8621W was achieved using hand layup technique.

Step c):

The epoxy matrix was partially cured inside an oven at 60° C. for 30 minutes thus giving prepreg with 15.6% cured matrix.

Step d):

Composite parts [0₂] were prepared for autoclave curing using hand layup technique by stacking two prepreg layers obtained in step c) above on the tool plate. During the stacking, ancillary materials—breather, bleeder and release film—were applied both above and under the sample, release film being next to the sample and breather being against both the tool plate below and the bagging film above the sample. The bleeder was between release film and breather layers (see FIG. 13);

Step e):

The final part was obtained by curing composite prepared in step d) in an autoclave at 177° C. for 150 min. Pressure (41.4 kPa) and vacuum (84.6 kPa) were applied to help compact the laminate, suppress voids and facilitate gasses extraction (see FIG. 15).

From the composite parts obtained in step e) coupons for thermal diffusivity measurement were cut using a cutting knife. The size of the coupons was 12.7×12.7 mm. The thickness is recommended as a function of expected thermal diffusivity. For materials with low thermal diffusivity, coupon thickness should be 1 mm or less with the upper and lower surface as flat and parallel as possible. Samples flatness as well as top and bottom surfaces parallelism were assured via tooling and stacking sequence. The thickness was determined as an average of five values measured at coupon corners and the centre using micrometer. These three dimensions provided for the volume of the coupon. A coupon density is determined by dividing the measured mass of the coupon by the calculated volume of the coupon. Density is a parameter required to calculate thermal conductivity per the following equation 1 before.

Each of the above properties is determined independently of one another prior to combining them into equation (1). While density is considered to be constant in the measured temperature range, thermal diffusivity and specific heat are temperature dependent, thus providing temperature dependent thermal conductivity.

Three measurements are taken into account to determine the specific heat of a sample. One is the baseline measurement, the second one is the reference material measurement and the third one is the sample measurement. The software provided by DSC manufacturer is used to calculate Cp for each sample utilizing the above three measurements.

All samples measurements, baseline measurement and reference measurement were completed per following procedure:

1. Equilibrate at 0° C.;

2. Isothermal for 10 min;

3. Ramp 20° C./min to 140° C.;

4. Equilibrate at 140° C.; and

5. Isothermal for 10 min.

Samples thermal diffusivity was established with the flash method according to standards ASTM E-1461, DIM EN 821 and DIN 30905 [Operating instructions LFA447™ Nanoflash—Netzsch]. Measurement was competed at three points: 25° C., 75° C. and 125° C. Thus obtained values were combined to obtain thermal conductivity (ISS) per EQ. The results are presented in Table 4:

Samples DR1, DR2 and DR3 contain 1 wt %, 2 wt % and 3 wt % of raw CNTs respectively. Obtained thermal conductivity results for type C and DR samples are presented in Table 2.1.

TABLE 2.1
Thermal conductivity for type C and DR samples

| | κ [W/mK] | | | κ-Relative Increase [%] | | |
|---|---|---|---|---|---|---|
| T [° C.] | 25 | 75 | 125 | 25 | 75 | 125 |
| | 0.711 ± 0.179 | 0.978 ± 0.000 | 1.127 ± 0.042 | | | |
| | 1.058 ± 0.088 | 1.179 ± 0.092 | 1.265 ± 0.120 | 48.8 | 20.5 | 12.2 |
| | 1.534 ± 0.097 | 1.626 ± 0.091 | 1.746 ± 0.042 | 115.6 | 66.2 | 55.0 |
| | 1.710 ± 0.009 | 1.842 ± 0.010 | 1.943 ± 0.001 | 140.4 | 88.3 | 72.4 |

Thermal conductivity varies both with CNTs weight content and temperature.

Thermal conductivity of samples made using standard stacking sequence and improved stacking sequence

| | κ[w/mK] | | | κ-Relative Increase [%] | | |
|---|---|---|---|---|---|---|
| t [° C.] | 0.854 ± 0.070 | 0.983 ± 0.080 | 0.957 ± 0.076 | | | |
| | 1.034 ± 0.125 | 1.175 ± 0.128 | 1.104 ± 0.104 | 21.1 | 19.5 | 15.4 |
| | 1.008 ± 0.153 | 1.174 ± 0.173 | 1.209 ± 0.177 | 18.0 | 19.5 | 26.3 |

The thermal conductivity presents increase of 18% at 25° C. over 19.5% at 75° C. to 26.3% at 125° C. over coupons made from composite material (AP) produced via the above described using different—standard—ancillary material stacking sequence in step d). The stacking sequence used in the production of the (AP) composite material was as follows: liquid release agent was applied on the curing tool; the composite part was put on thus prepared curing tool; release film, bleeder and breather were respectively stacked on the top surface of the part; vacuum bag was then used as in the production of (ISS) part. Thermal conductivity of (AP) sample was determined in the same manner as for the (ISS) sample. The reason for the difference in thermal conductivities between the (AP) and (ISS) parts is the accumulated matrix against the tool plate in part (AP) (see FIG. 12). This accumulated matrix is eliminated in the (ISS) part. This is confirmed via very close thermal conductivities between (ISS) parts and (SB) parts. (SB) parts are obtained by removing the accumulated matrix from the (AP) parts via sending.

It has been shown herein that the above described stacking sequence improves nanocomposite part thermal conductivity. A practical use of improved stacking sequence described above has been demonstrated in the example. The application of bleeder and breather both above and below the sample significantly increases nanocomposite part thermal conductivity.

### CNT Quality Example

The following examples are for Carbon nanotubes (CNTs) as nanomaterial, carbon fibers (CFs) as fibers and epoxy as polymer for the making of the composite. It is to be understood that the invention should not be limited to these specific examples.

This specific example is demonstrating the importance of CNT (nanomaterial) quality for thermal conductivity improvement. The quality as defined above is determined by the perfection of the nanomaterial crystal lattice. Lower number of imperfections means better quality of the nanomaterial.

By similarity of the phenomena, it is reasonable that the quality would have similar importance on other transport properties, without limitation to it or exclusion of others, electrical conductivity.

To evaluate CNTs quality impact on thermal conductivity, thermal conductivities of samples made with the same weight loading of different quality CNTs were compared at about 25° C., at about 75° C. and at about 125° C.

Referring to FIG. 1, the composites were made in accordance with a preferred embodiment of the invention. The method generally comprises the steps as previously disclosed herein.

### Example

This example serves to illustrate how the CNTs quality impacts nanocomposite thermal conductivity.

Materials with good thermal conductivity can be used in applications where heat dissipation is required.

The present example is focused on the effect of incorporation of CNTs of different quality in a CFRP in an attempt to achieve improved thermal conductivity of a composite constituting of SWNT, PAN based carbon fibres and epoxy matrix.

### Materials

Raw (R), purified (P) and super purified (SP) SWNTs were purchased from Unidym, Inc. (Houston, Tex.). SWNTs were produced by HiPCO process. HiPCO CNTs were chosen as they promised the highest improvement of thermal conductivity [M. J. Biercuk, M. C. Llaguno, M. Radosavljevic, J. K. Hyun, A. T. Johnson, J. E. Fischer; Applied Physic Letters 2002, 80: 2767-2769]. TGA residuals (as Fe) in this commercial material were 16.5% for RCNTs, 8% for PCNTs and 4% for SPCNTs 16.5%. Selected matrix is the system obtained by combination of bisphenol-F epoxy resin Epon 862 and aromatic amine curing agent Epicure W. This system has very long working life at room temperature and high operational temperature when cured. Low room temperature viscosity allows better manufacturing process, hand lay-up utilised in samples manufacturing was facilitated by this material property. This system was purchased from Hexion Specialty Chemicals, Inc. The matrix properties are presented in Table 1.

Carbon fibre fabric HexForce® G0947 D 1040 TCT is a carbon fabric produced by Hexcel from high strength PAN based carbon fibres. Warp material are 3 k yarns made utilising HTA 5131 carbon fibres. The fibre density is 1760 kg/m³. Weft yarns EC5 5.5×2 are made utilising glass fibres. Fabric content is 97% warp and 3% weft. Material thickness is 0.16 mm. Material nominal weight is 160 g/m².

Solvent used was DI water. Perforated release film resistant to high temperatures of up to 200° C. was used. Felts bleeder and breather resistant to high temperatures of up to 200° C. were used. Curing tool used was aluminium tool plate. Vacuum bag used was made of polymer alloys resistant to high temperatures of up to 200° C. Vacuum bag sealant tape—two side sealant tape used was sealant tape resistant to high temperatures of up to 200° C.

### Production of Composite Material

Composites in this example were produced with 3 wt % of SWNTs. The concentration of SWNTs was determined relatively to the dry carbon fibre preform.

For the preparation of FRP composite material the method used was comprising the steps of a) incorporating SWNTs into the carbon fibre preforms (see FIG. 1). The preforms were obtained by cutting carbon fibres fabric to dimensions 0.22×0.022 m; b) impregnation of composite material obtained in step a) with epoxy matrix using hand layup technique; c) partially curing the material obtained in step b in oven for 30 min at 60° C. in order to obtain a prepreg; d) preparing [O₂] samples for autoclave curing using hand layup technique by stacking two prepreg layers on the tool plate. During the stacking, breather, bleeder and release film were applied both above and under the sample, release film being next to the sample and breather being against both the tool plate below and the bagging film above the sample. The bleeder was between release film and breather layers (see FIG. 13); e) curing thus prepared composite in an autoclave at 177° C. for 150 min. Pressure (41.4 kPa) and vacuum (84.6 kPa) were applied to help compact the laminate, suppress voids and facilitate gasses extraction (see FIG. 15).

### Step a)

The CF preform was cut to dimensions 0.22×0.022 m. The preform was weighed using balance with precision of 0.0001 g. In order to retain CFs preform rectangular form and hold CFs together, both preform ends were fixed using epoxy matrix that cures at room temperature.

SWNT mass was measured using the same balance as for the CF preform.

Incorporation of SWNTs into the carbon fibre preform was completed per method schematically shown in FIG. 1. For the first iteration, 1 wt % of measured CF preform was measured and used. Measured CNTs were mixed in a glass beaker with 120 ml of DI water (see FIG. 2). CNTs were dispersed in DI water with the aid of ultrasound applied for 30 min using a high power cuphorn ultrasonic processor—the power switch was set at the middle of the range. During sonication, the beaker was held in ice bath in order to maintain the processing temperature constant. Thus obtained solution was used to impregnate the CF preform. Ultrasound was applied to the impregnated CF preform using an ultrasonic bath while the temperature was maintained constant using ice bath. When the solution became clear, the solvent was removed from the impregnated preform by holding the impregnated preform taken out of the solution in an oven at 120° C. for 24 hours. This was the first iteration of addition of CNTs in the CF preform. Another 1 wt % of CNTs was measured. The measured CNTs were mixed in a glass beaker with 120 ml of DI water and the above described process was repeated. The difference was that in this iteration, composite material comprising CF and CNTs, obtained after the previous iteration was used as CF preform. When the current iteration was completed the third iteration was done with another 1 wt % of CNTs. In this third iteration, CNT/CF composite obtained after the second iteration was used as CF preform. When the current iteration was completed, the composite material comprising CF and CNTs was weighed using the same balance as above. The result showed that 3 wt % of CNTs was incorporated into the CF preform. Exception was one DR3 sample that had additional iteration as described in the example 1.

### Step b)

Impregnation of impregnated CF preform obtained in step a) with epoxy matrix system Epon 8621W was achieved using hand layup technique.

### Step c)

The epoxy matrix was partially cured inside an oven at 60° C. for 30 minutes thus giving prepreg with 15.6% cured matrix.

### Step d)

Composite parts [O₂] were prepared for autoclave curing using hand layup technique by stacking two prepreg layers obtained in step c) on the tool plate. During the stacking, ancillary materials—breather, bleeder and release film—were applied both above and under the sample, release film being next to the sample and breather being against both the tool plate below and the bagging film above the sample. The bleeder was between release film and breather layers (see FIG. 13);

### Step e)

The final part was obtained by curing composite prepared in step d) in an autoclave at 177° C. for 150 min. Pressure (41.4 kPa) and vacuum (84.6 kPa) were applied to help compact the laminate, suppress voids and facilitate gasses extraction (see FIG. 15).

From the composite parts obtained in step e) coupons for thermal diffusivity measurement were cut using a cutting knife. The size of the coupons was 12.7×12.7 mm. The thickness is recommended as a function of expected thermal diffusivity. For materials with low thermal diffusivity, coupon thickness should be 1 mm or less with the upper and lower surface as flat and parallel as possible. Samples flatness as well as top and bottom surfaces parallelism were assured via tooling and stacking sequence. The thickness was determined as an average of five values measured at coupon corners and the centre using micrometer. These three dimensions provided for the volume of the coupon. A coupon density is determined by dividing the measured mass of the coupon by the calculated volume of the coupon. Density is a parameter required to calculate thermal conductivity per equation (1).

Each of the above properties is determined independently of one another prior to combining them into equation (1). While density is considered to be constant in the measured temperature range, thermal diffusivity and specific heat are temperature dependent, thus providing temperature dependent thermal conductivity.

Three measurements are taken into account to determine the specific heat of a sample. One is the baseline measurement, the second one is the reference material measurement and the third one is the sample measurement. The software provided by DSC manufacturer is used to calculate Cp for each sample utilizing the above three measurements.

All samples measurements, baseline measurement and reference measurement were completed per following procedure:

1. Equilibrate at 0° C.

2. Isothermal for 10 min.

3. Ramp 20° C./min to 140° C.

4. Equilibrate at 140° C.

5. Isothermal for 10 min.

Samples thermal diffusivity was established with the flash method according to standards ASTM E-1461, DIM EN 821 and DIN 30905 [Operating instructions LFA 447™ Nanoflash—Netzsch]. Measurement was competed at three points: 25° C., 75° C. and 125° C.

The above procedure was repeated for each of the samples containing R, P and SP CNTs. Three samples were produced in separate batches with each of the R, P and SP CNTs.

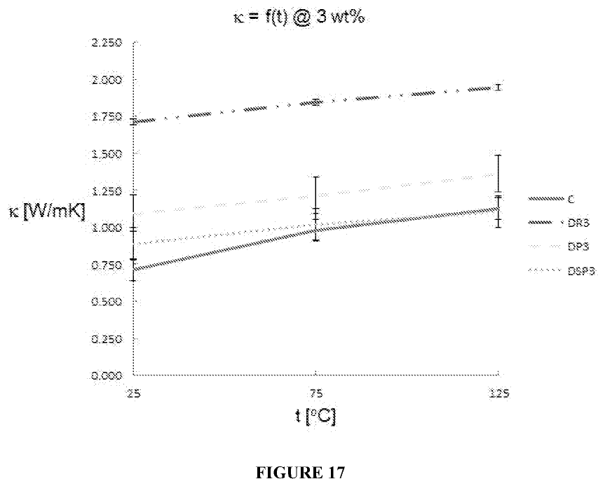

Thus obtained values were combined to obtain thermal conductivity (DR3-raw CNTs, DP3-purified CNTs and DSP3-super purified CNTs) per EQ. 1. The results are presented in table 5 and FIG. 17.

Thermal conductivity for Type C, DR3, DP3 and DSP3 samples.

| | κ[w/mκ] | | | κ-Relative Increase [%] | | |
|---|---|---|---|---|---|---|
| T [° C.] | 25 | 75 | 125 | 25 | 75 | 125 |
| | 0.711 ± 0.179 | 0.978 ± 0.000 | 1.127 ± 0.042 | | | |
| | 1.710 ± 0.009 | 1.842 ± 0.010 | 1.943 ± 0.001 | 140.4 | 88.3 | 72.4 |
| | 0.978 ± 0.149 | 1.134 ± 0.112 | 1.289 ± 0.111 | 37.4 | 15.9 | 14.3 |
| | 0.890 ± 0.108 | 1.017 ± 0.103 | 1.108 ± 0.109 | 25.0 | 4.0 | −1.7 |

In order to discuss CNT quality impact, it is important to define the CNT quality with respect to thermal conductivity.

In graphite crystal lattice heat is transferred by acoustic phonons. Boundary scattering and lattice imperfections like carbon atom displacement, either in plane or out of its plane, carbon atoms missing, inclusions in the form of either carbon or a different atom all lead to a reduction of the phonon mean free path and as a consequence a reduction in thermal conductivity [J. M. Ziman: Electrons and Phonons: The Theory of Transport Phenomena in Solids, Oxford Scholarship Online, 2007; B. T. Kelly: Physics of Graphite, Applied Science Publishers, 1981]. Hence, higher number of defect sites means lower thermal conductivity of a CNT. Therefore, a CNT without any imperfections would be the CNT with the highest thermal conductivity, i.e. the highest quality CNT.

The most common method for CNTs purification is acid treatment. In this manner, as described in literature, ash content is reduced. A negative side of the acid treatment is damaging of CNTs' side walls [S. Wang, R. Liang, B. Wang, C. Zhang; Carbon 2009, 47: 53-57; S.-Y. Yang, C.-C. M. Ma, C.-C. Teng, Y.-W. Huang, S.-H. Liao, Y.-L. Huang, H.-W. Tien, T.-M. Lee, K.-C. Chiou; Carbon 2010, 48: 592-603.].

It is reasonable to assume that lower levels of ash content would require acid treatment that would infer higher number of individual defects to CNTs, thus reducing CNTs thermal conductivity. Therefore, for CNTs produced by the same method and with the same production parameters, as produced CNTs would have the lowest number of defects and hence the highest thermal conductivity, thus being the CNTs of the highest quality with respect to thermal conductivity. CNTs purified via acid treatment would have lower thermal conductivity, therefore being the CNTs of lower quality.

In the case of CNTs used in the current study, based on the above, RCNTs would be the CNTs with the highest quality of the three. PCNTs would be the CNTs with the second highest quality and the SPCNTs would be the CNTs with the lowest quality with respect to heat transfer.

Obtained thermal conductivities of samples made with 3 wt % of RCNTs are significantly higher than thermal conductivities of samples made with either PCNTs or SPCNTs. The difference is more pronounced at about 25° C. (about 75%-92%) than at other two testing temperature points. The difference at about 125° C. is about 51% and about 75% with respect to DP3 and DSP3 samples respectively. The difference can be considered very significant.

Applicant has shown that the CNTs quality plays a significant role in nanocomposite part thermal conductivity improvement.

A practical use of CNT quality importance described above has been demonstrated in the example. The application of CNTs with better quality significantly more increase nanocomposite part thermal conductivity compared with CNT of lower quality.

Composite materials thermal conductivity is a challenging area. This is particularly applicable in the through thickness direction. Obstacles on the path of improvement are numerous. To overcome issue of carbon nanotube distribution within composite a new approach was adopted. Carbon nanotubes were added to thin carbon fiber fabric, creating a new material to be impregnated by matrix. This was achieved with employment of ultrasound to obtain a basic building block for the layer-by-layer method. Laminate was prepared from prepreg layers utilizing ancillary materials stack-up sequence optimized for thermal conductivity improvement through nanomaterials. Autoclave cured materials were examined for thermal conductivity. The highest value was achieved at 125° C. The highest improvement over reference carbon fiber/epoxy composite material was obtained at 25° C. Three different carbon nanotube materials were used in the research. Least damaged carbon nanotubes yielded the best results. Simple calculations completed on carbon nanotube/epoxy composites confirmed the least damaged carbon nanotubes—the carbon nanotubes of the highest quality—as the best heat transport medium.

While illustrative and presently preferred embodiment(s) of the invention have been described in detail hereinabove, it is to be understood that the inventive concepts may be otherwise variously embodied and employed and that the appended claims are intended to be construed to include such variations except insofar as limited by the prior art.

1. A method for the making of a composite of nanomaterials and fibers, the method comprising the steps of:
a) dispersing a given amount of nanomaterials into a solvent to obtain a solution while maintaining the solution at a first constant temperature in order to uniformly disperse the nanomaterial in the solvent;
b) impregnating a dry fiber preform comprising fibers with the solution obtained in step a);
c) incorporating the nanomaterials into the fiber preform by applying ultrasound to the impregnated fiber preform obtained in step b) at a second constant temperature;
d) removing the solvent from the impregnated fiber preform obtained in step c);
e) iterating steps a) to d) at least once wherein in iterated step b) the fiber preform is replaced with the impregnated fiber preform obtained in step d) in the previous iteration, until to obtain a first amount of nanomaterial incorporated into the composite;
wherein the composite comprises nanomaterials with a concentration up to 50 wt %.

2. The method of claim 1, further comprising, after step e), a step f) of weighing the composite to precisely determine the first amount of incorporated nanomaterials when all nanomaterials intended for incorporation in the fiber preform were used during iterating steps e).

3. The method of claim 2, further comprising the step of reiterating steps a) to e) at least once with the difference that, in the step b), the composite obtained after the step e) in the previous iteration replaces the impregnated fiber preforms.

4. The method of claim 2, further comprising the step of combining the nanomaterial-fiber composite with a matrix to form a prepreg composite.

5. The method of claim 4, wherein the matrix comprises thermoset and/or thermoplastic polymers.

6. The method of claim 5, wherein the matrix comprises epoxy.

7. The method of claim 1, wherein the nanomaterials comprise carbon nanotubes (CNTs), graphene, nanoclay, microcapsules or mixture thereof.

8. The method of claim 7, wherein the nanomaterials are CNTs being single wall carbon nanotubes (SWNTs), double wall carbon nanotubes (DWNTs), multiwall carbon nanotubes (MWNTs), as produced, pretreated, functionalized or any combination thereof.

9. The method of claim 7, wherein the graphene is in the form of graphene nanoplatelets, graphene oxide, graphene flakes or mixture thereof.

10. The method of claim 1, wherein the solvent is deionized water, acetone, ethanol, N-methylpyrrolidone (NMP), dimethylformamide (DMF) or mixture thereof.

11. The method of claim 1, wherein the fibers of the fiber preform comprise carbon fibers, glass fibers, polyaramid paraphenylene terephthalamide fibres, mixture or combination thereof.

12. The method of claim 1, wherein the constant temperatures in steps a) and c) are maintained about 0° C. using an ice bath.

13. The method of claim 1, wherein in step e), the solvent is removed by heating the impregnated fiber preform.

14. A composite of nanomaterials and fibers obtained by:
a) dispersing a given amount of nanomaterials into a solvent to obtain a solution while maintaining the solution at a first constant temperature in order to uniformly disperse the nanomaterial in the solvent;
b) impregnating a dry fiber preform comprising fibers with the solution obtained in step a);
c) incorporating the nanomaterials into the fiber preform by applying ultrasound to the impregnated fiber preform obtained in step b) at a second constant temperature;
d) removing the solvent from the impregnated fiber preform obtained in step c);
e) iterating steps a) to d) at least once wherein in iterated step b) the fiber preform is replaced with the impregnated fiber preform obtained in step d) in the previous iteration, until to obtain a first amount of nanomaterial incorporated into the composite,
wherein the composite comprises nanomaterials with a concentration up to 50 wt %, and
wherein the nanomaterials comprises:
graphene, nanoclay, microcapsules or mixture thereof;
a mixture of graphene and carbon nanotubes (CNTs);
a mixture of nanoclay and CNTs;
a mixture of microcapsules and CNTs;
a mixture of graphene, nanoclay and CNTs;
a mixture of graphene, microcapsules and CNTs;
a mixture of microcapsules, nanoclay and CNTs; or
a mixture of graphene, microcapsules, nanoclay and CNTs.

15. The composite of claim 14, further comprising a matrix to form a prepreg composite.

16. The composite of claim 14, wherein the composite has a thermal conductivity superior or equal to about 1.058 W/mK measured with a temperature equal or superior to about 25° C.

17. The composite of claim 14, wherein the fibers comprise carbon fibers, glass fibers, polyaramid paraphenylene terephthalamide fibers, mixture or combination thereof.

18. The composite of claim 14, wherein said fibers define a longitudinal axis and comprises said nanomaterials surrounding each fiber, and wherein the nanomaterials are uniformly distributed within a space between the fibers and at least a portion of the nanomaterials is attached to the fiber and extends from a surface of the fiber.

19. The composite of claim 18, wherein when the nanomaterials comprises CNTs, the CNTs attached to the fibers extend from a surface of the fiber with substantially perpendicular direction to the fiber longitudinal axis.

20. An ancillary material stacking sequence comprising the following sequences:
a. at least one first breather placed against a curing tool;
b. at least one first bleeder placed on the first breather(s);
c. a first release film placed on the first bleeder(s);
d. a prepreg composite comprising the composite of nanomaterials and fibers as claimed in claim 14 and a matrix, the prepreg composite being placed on the release film;
e. a second release film placed on the prepreg composite;
f. at least one second bleeder placed on the second release film;
g. at least one second breather placed on the second bleeder(s); and
h. a vacuum bag sealed on the second breather(s) and the curing tool.

21. The ancillary material stacking sequence of claim 20, wherein surfaces of a resulting composite product are rich in nanomaterials and contains substantially optimal quantity of the matrix.
